(19) United States
(12) Patent Application Publication
(10) Pub. No.: US 2026/0237540 A1
(43) Pub. Date: Aug. 13, 2026

(54) ELECTRICAL CONDUCTOR ASSEMBLY

(71) Applicant: KK Wind Solutions A/S, Ikast (DK)

(72) Inventors: Jorgen Dahl Vestergaard, Kibaek (DK); Poul Thing, Ikast (DK); Bjorn Rannestad, Aalborg (DK)

(21) Appl. No.: 19/469,316

(22) PCT Filed: Mar. 22, 2024
(86) PCT No.: PCT/DK2024/050068

§ 371 Date: Sep. 25, 2025

(30) Foreign Application Priority Data
Mar. 28, 2023 (DK) PA202370156
Apr. 27, 2023 (DK) PA202370206
May 26, 2023 (DK) PA202370262

(51) Int. Cl. H01B 9/00; H01B 7/02; H01B 13/06

(52) U.S. Cl. CPC H01B 9/00; H01B 7/02; H01B 13/06

(57) ABSTRACT

An electrical conductor assembly includes an electrically conducting component and an electrically insulating component. The electrically conducting component is configured to conduct an electrical current between a first terminal and a second terminal of the electrical conductor assembly. At least one of the electrically conducting component and the electrically insulating component is manufactured by additive manufacturing, for example to provide partial electrical insulation of the electrical conductor. An electrical system includes electrical components connected to electrical conductors, of which one or more are an electrical conductor assembly having an electrically conducting component and an electrically insulating component, at least one of which being manufactured by additive manufacturing. A method includes manufacturing an electrical conductor assembly by assembling an electrically conducting component and an electrically insulating component. The method further includes manufacturing the electrically conducting component and/or the electrically insulating component by additive manufacturing.

### FIELD OF THE INVENTION

The present invention relates to an electrical conductor assembly which is at least partly manufactured by additive manufacturing.

### BACKGROUND OF THE INVENTION

Electrical conductor assemblies having at least one conductor and at least one insulator, are mass-produced in form of cables, etc., where the same cross section of conductor assembly is desired for the entire length of cable. However, traditional conductor assembly manufacturing is not able to produce conductor-insulator assemblies that have complex shapes, vary along their length, feature additional functions at various positions, etc.

### SUMMARY OF THE INVENTION

The inventors have identified the above-mentioned problems and challenges related to electrical conductor assemblies, and subsequently made the below-described invention which may allow for one or more of improved shapes, improved or additional functions, reduced material consumption and weight, and more as described herein.

The invention relates to an electrical conductor assembly comprising an electrically conducting component and an electrically insulating component, wherein said electrically conducting component is configured to conduct an electrical current between a first terminal and a second terminal of said electrical conductor assembly, wherein at least one of said electrically conducting component and said electrically insulating component is manufactured by additive manufacturing.

Combining insulating and conducting material in one assembly which is at least partly 3D-printed or otherwise manufactured by additive manufacturing, may be highly advantageous, as it facilitates more freely designing shapes, geometries, profiles, etc., of the conductor assembly, for example when utilizing the opportunity in additive manufacturing of producing geometries or profiles that would not be possible to manufacture by traditional methods like moulding or extrusion. Likewise, new features of electrical conductor assemblies may be facilitated by the present invention, which are also not possible or feasible to achieve with traditional methods.

More detailed examples are described below with reference to the drawings, while here just mentioning a few non-limiting examples, such as an electrical conductor assembly having integrated insulation inside channels in the conducting component to allow internal cooling or insertion of wires, sensors, etc.; an electrical conductor assembly being insulated on a non-uniform web-like or bionic-like part of the conducting component to facilitate better cooling or flexibility while still ensuring proper insulation; targeted partly or non-uniform coverage by insulation at exposed or accessible portions of the electrical conductor assembly in particular for high-power systems; inherent non-insulation by design at terminals and other locations where access to the conducting component is required to avoid manual removal of insulation with possible damaging the conductor at such locations; an electrical conductor assembly having several conductors or conductor strand or branches which are interweaved in a way that is not easily achieved by combining individually manufactured conductors, and which require insulation between them to allow for small inter-conductor distances; an electrical conductor assembly having insulated mounting points thereby avoiding manually adding mounting points and insulation in post-proceeding or mounting on non-conducting structure; an electrically insulating component may be manufactured utilizing the opportunities and advantages of additive manufacturing, and conducting material is applied to form an electrical conductor assembly; an electrically conducting component may be manufactured utilizing the opportunities and advantages of additive manufacturing, and insulating material is applied to form an electrical conductor assembly; etc.

The present invention may be particularly advantageous for specialized electrical conductor assemblies where certain shape, flexibility, rigidity, cooling options, mounting, terminals, etc., is required or beneficial in combination with certain insulation requirements. An electrical conductor assembly with one or more of a complex shape, integrated flexibility at a certain location, larger cooling surface area than simple circular or rectangular cross sections allow, with predetermined mounting points and terminal points, targeted partial insulation or internal insulation, etc., may advantageously be provided by manufacturing one or more conducting component, one or more insulating component, or both kinds of components of the electrical conductor assembly by additive manufacturing.

An electrical conductor assembly is understood as an assembly of one or more electrically conducting components and one or more electrically insulating components. An electrically conducting component is configured to conduct an electrical current between a first terminal and a second terminal of the electrical conductor assembly. The electrical conductor assembly may be assembled in one process by multi-material additive manufacturing, or be assembled by providing one of the components from additive manufacturing or conventional manufacturing, and adding the other, e.g. by additive manufacturing or surface treatment. According to the invention, at least one of the components in the assembly is manufactured by additive manufacturing.

An electrically insulating component is configured to provide electrical insulation of one or more of the electrically conducting components, for example of the entire surface, selected parts of the surface, or between electrically conducting components that are intended to carry individual electrical potential. The electrical insulating component may be based on or contain a material, such as a solid or enclosed liquid or gas, in which electric current does not flow freely, i.e. has a higher, preferably significantly higher, electrical resistivity than materials typically used for conductors and semiconductors. As all insulators may conduct very small currents and/or breakdown at certain high voltages or temperatures, the material and design of the electrically insulating component is preferably based on the intended properties and use case of the electrical conductor assembly, in particular its electrical and thermal properties such as intended voltage and current, required thermal endurance, the physical dimensions of the conductor assembly and distances to other conductors, structures or persons during use. For instance, a different insulation material and/or thickness may be selected for high-voltage conductor assemblies compared to conductor assemblies intended for low-volage electronics.

All, some or at least one of the components are manufactured by additive manufacturing, also popularly referred to as 3D printing. Such manufacturing process may be based on, but not limited to, one of the following additive manufacturing processes: 3D printing, layer by layer printing, Wire Arc Additive Manufacturing, Fused Deposition Modeling FDM, Direct Energy Deposition, Direct Metal Deposition, sintering based processes, laser based processes such as selective laser melting SLM or selective laser sintering SLS, cold spray additive manufacturing CSAM, etc. The particular additive manufacturing technology to utilize may be selected based on the requirements for materials, such as copper, aluminum or alloys for conductors and various plastics or plastic-like materials for insulators, as well as based on the desired extend of the electrical conductor assembly, manufacturing precision, etc. In embodiments where several components, possibly from different materials, are manufactured by additive manufacturing, the manufacturing technology may preferably support application of different materials in one work process, such as simultaneously or synchronously, such as alternatingly, to facilitate producing the electrical conductor assembly as one single workpiece. Synchronously, as used herein, refers to coordination in time and/or space, for example providing two different materials at two different locations on the part at the same time, or providing two different materials alternatingly, for example providing the conducting material for a particular additive manufacturing layer, then the insulating material for the same particular layer, then moving on with the conducting material for the next layer, etc. Additive manufacturing technologies supporting applying two or more materials simultaneously, synchronously or alternatingly, i.e. multi-material additive manufacturing, may for example include fused deposition modeling FDM when provided with two nozzles and two filaments, one being a conducting material and the other an insulating material, or may for example include cold spray additive manufacturing CSAM when provided with two spray nozzles for spraying conductive and insulating material, respectively. Other two-material 3D printing technologies also exist, including combinations of two technologies for conducting parts and insulating parts, respectively. Multi-material additive manufacturing, as used herein, generally means that a part consisting of more than one material, can be produced using additive manufacturing without intermediary manual steps being required, such as moving a part from a metal printer to a plastic printer, or the like.

In an embodiment, said electrically insulating component is manufactured together with said electrically conducting component by multi-material additive manufacturing.

Complex electrical conductor assemblies requiring insulation may advantageously be produced by multi-material additive manufacturing, where an electrically insulating material and an electrically conducting material are applied alternatingly or simultaneously to form the desired electrical conductor assembly, thereby enabling creation of conductor assemblies that would not be possible to obtain as one single piece before. For electrical conductor assemblies where one of the components are not necessary to manufacture by additive manufacturing, it may anyway be beneficial to utilize multi-material additive manufacturing to achieve the complete assembly in one process step. Some of the possible technologies for multi-material additive manufacturing are mentioned above.

In an embodiment, wherein said electrically conducting component is manufactured by additive manufacturing and wherein said electrically insulating component is provided at least partially onto a surface of said electrically conducting component by surface treatment.

Advantageously, a 3D-printed electrically conducting component may be coated or otherwise provided with electrically insulating material to form the electrical conductor assembly. The surface treatment providing the electrically insulating component may apply to the entire surface of the conducting material, possibly except the terminals thereof, or it may be applied partially, for example at selected portions of the conductor surface, for example where a sufficient safety clearance air gap to nearby conducting parts is not feasible, or to reduce the risk for operators or service technicians.

Surface treatment, as used here and elsewhere herein, may comprise any technology or process of applying or creating a substance on a surface of another substance. Surface treatment may for example comprise coating with a separate substance, where examples of suitable coating methods comprise painting, spraying, dipping, powder coating, plating, shrinking, physical or chemical vapor deposition PVD/CVD, low temperature arc vapor deposition LTAVD, ion beam assisted deposition IBAD, etc. Surface treatment may alternatively or in addition comprise conversion coating, where a surface is modified to achieve different properties, where examples of suitable conversion coatings comprise chromating, phosphating, anodizing, hard anodizing, patination, plasma electrolytic oxidation PEO, etc.

The electrically conducting component may for example be provided with an electrically insulating component at select portions by thermal spraying of ceramic coating, powder coating or dip coating with thermoplastics, painting with non-conducting paint, cold spray additive manufacturing with a polymer, etc.

In an embodiment, wherein said electrically conducting component is manufactured by additive manufacturing onto a surface of said electrically insulating component.

The electrically insulating component may be provided from, e.g., a molding process or any other manufacturing technology for insulating components, including a separate additive manufacturing process, e.g. stereolithography SLA. The electrically insulating component may for example be in the form of an elongated sheet or slab, a U-shape profile half pipe, etc., onto which the electrically conducting component can be created by additive manufacturing to form together an electrical conductor assembly having insulation on at least one side. The pre-manufactured electrically insulating component may also be a complex geometry, allowing for more complex insulation in the final assembly.

In an embodiment, wherein said electrically insulating component is manufactured by additive manufacturing and wherein said electrically conducting component is provided at least partially onto a surface of said electrically insulating component by surface treatment.

Advantageously, a 3D-printed electrically insulating component, e.g. made by FDM, SLA or SLS, may be coated or otherwise provided with electrically conducting material to form the electrical conductor assembly. The surface treatment providing the electrically conducting component may apply to the entire surface of the insulating material, or it may be applied partially, for example as conducting bands along the elongation of the insulator surface. The application of the electrically conducting component to the electrically insulating component should achieve one or more unbroken conductive paths between at least the first and second terminals in order to enable conduction of electrical current.

The description of surface treatment described above also applies here, with examples of surface treatment to provide an electrically conducting component comprising powder coating or painting with a copper or aluminum based coat, cold spray additive manufacturing with electrically conducting alloys, etc.

In an embodiment, wherein said electrically insulating component is manufactured by additive manufacturing onto a surface of said electrically conducting component.

The electrically conducting component may be provided from, e.g., extrusion or a molding process or any other manufacturing technology for conductors, including a separate additive manufacturing process, e.g. selective laser melting SLM. The electrically conducting component may for example be in the form of an elongated sheet or slab, a bar or rail, etc., onto which the electrically insulating component can be created by additive manufacturing to form together an electrical conductor assembly being at least partly insulated. The pre-manufactured electrically conducting component may also be a complex geometry, such as web-like or bionic, onto which insulation is applied by additive manufacturing to form the final assembly. The application of electrically insulating component by additive manufacturing may for example be achieved by fused deposition molding, cold spray additive manufacturing, stereolithography, etc.

In an embodiment, wherein said electrically insulating component is manufactured by additive manufacturing to form a channel, and wherein said electrically conducting component is applied in said channel in fluid form.

Using a fluid form, preferably liquid, of an electrically conducting component may be advantageous in facilitating filling out the channel in the electrically insulating component to form a continuous electrically conducting component between the first and second terminals. The material for the electrically conducting component may be selected to solidify once inserted, or it may stay fluid. An electrically conducting component not only applied in fluid form but also utilized as conductor in fluid form may be pumped or otherwise made to flow through the channel while conducting, thereby allowing cooling of outflowing conductor fluid, and feeding the channel with cooled conductor fluid. The fluid electrically conducting component may for example be directed through a heat sink or heat exchanger before being re-introduced into the channel. Fluids that can be used as conductors in liquid form, in a non-limiting example, comprise mercury, gallium-indium alloy, gallium-indium-tin alloy, and electrolytes.

In an embodiment, wherein said electrically conducting component applied in said channel in fluid form is subsequently solidified.

Utilizing the 3D-printed electrically insulating component as a mold to receive a fluid conducting material and allowing it to solidify in the channel in the insulation provides for interesting opportunities with respect to achieving conductor shapes. As long as it is avoided to trap air in the mold, the conducting material will form a well-established conductor once solidified. This embodiment may provide an alternative to manufacturing the conducting component by, e.g., metal 3D-printing. In an embodiment the channel is not a closed pipe, but rather one or more open grooves in the surface of the insulating component, in which the fluid electrical conductor material can run.

In an embodiment, the electrically conducting component and the electrically insulating component are arranged substantially parallel in said electrical conductor assembly.

In various embodiments, it may be advantageous that the electrically conducting component is covered along for example a longitudinal direction by the electrically insulating component, at its outer surface and/or at an inner surface, such as a cooling channel.

In an embodiment, the electrically insulating component forms one or more transversal bands on the electrically conducting component.

In various embodiments, it may be advantageous that the electrically conducting component is covered with an insulating band at positions along its extent, at regular or irregular intervals, for example at mounting or support locations, or busbar crossings.

In an embodiment, said electrically conducting component comprises a first material and said electrically insulating component comprises a second material different from said first material.

In an embodiment, said first material is selected from the list of copper, aluminum, silver, gold, tin, steel, mercury, gallium, electrolyte, or alloys or combinations thereof.

In an embodiment, said second material is selected from the list of polymers, ceramics, thermoplastics, glass reinforced plastic, rubber, glass, wood, paper, oil, deionized water, or combinations thereof.

In embodiments where ceramic coating is feasible, this may be an advantageous option for the electrically insulating component, due to excellent electrical insulation properties, in combination with having better thermal conductivity than many other electrically insulating materials. In embodiments where a liquid insulator is feasible, oil may be an advantageous choice, as it may additionally serve as a cooling fluid.

In an embodiment, said electrical conductor assembly is an electrical busbar.

By electrical busbar is understood a component for electrical distribution in a system, e.g. in an electrical cabinet, including main busbars mounted along a top, back, side or bottom of a cabinet, or transition busbars, connecting busbars, shunts, etc., connecting electrical components or other busbars with the main busbars, in-or out-feed cables, etc.

Complete or partial electrical insulation of an electrical busbar may comprise a segment, surface area or otherwise part of the electrical busbar, which comprises an electrically insulating layer or separator to shield operators and technicians, allow for mounting on metallic structures, provide required separation to adjacent conductors, components or mechanical structures and/or reduce the risk of short circuits. 3D-printed electrical insulation regions located at selected portions of the busbar surface may avoid a manual post-process of applying electrical insulation material, avoid separate insulation elements for mounting and conductor crossings, and allow for irregular insulation region shapes and locations targeting the specific insulation requirements of the electrical system without any additional effort. An electrical insulation region provided by additive manufacturing may also comprise internal electrical insulation, e.g. inside a cooling channel to enable using more or less conductive cooling fluids, or be provided between busbar strands or co-printed two or more phase conductor busbars for busbar separation. Additive manufacturing of at least partly insulated busbars may also enable further auxiliary functions of the busbar which are difficult or impossible to achieve with traditional production methods, such as improved heat transfer by an open design with channels, web-like or bionic geometries.

In an embodiment, said electrical conductor assembly is a component configured for electrical distribution in an electrical system, e.g. in an electrical cabinet.

In an embodiment, said electrical conductor assembly comprises a main busbar to be mounted along a top, back, side or bottom of an electrical cabinet.

A main busbar should be understood as an electrical conductor distributing current in an electrical cabinet, a switchgear, panel board or busway enclosure, typically, from one or more cables entering the electrical cabinet to electrical components located inside the electrical cabinet. Typically, the main busbar extends in the width (X direction) or in the height (Y direction) of the electrical cabinet. The main busbar may be fastened to a back plate of the electrical cabinet.

In an embodiment, said electrical conductor assembly comprises a transition busbar, a connecting busbar or a shunt, configured to connect electrical components or other busbars with main busbars or cables.

A transition busbar, connecting busbar or shunt should be understood as a busbar connecting a main busbar or cable with another main busbar, another transition busbar, with an electrical component, or the like. A transition busbar may also be referred to as a connection or transition piece for connecting two or more electrical components. Typically, a transition busbar extends in two or more directions, where one of these directions is towards the opening of the electrical cabinet (Z direction). Another of these directions is typically perpendicular or parallel to e.g. the main busbar to which transition busbar is connected. The transition busbar may comprise two legs at one end for connecting e.g. two paralleled power modules to one main busbar or to another transition busbar. Transition busbar, connecting busbar or a shunt may also comprise a current balancing busbar to connect busbars, branches, terminals or conductors that ideally should be at the same electrical potential, e.g. corresponding terminals of parallel-coupled power modules or other components, thereby facilitating an improved distribution and balancing of current and heat among the terminals or branches.

In an embodiment, said electrically conducting component of said electrical conductor assembly comprises two or more, such as three, separate phase conductors, each having first and second terminals and supporting individual current conductance between the respective first and second terminals.

The electrically insulating component may be provided to separate the three separate phase conductors, to commonly insulate the assembly from surroundings, to provide mechanical support for the phase conductors, provide insulated mounting points for the electrical conductor assembly, or combinations thereof. This embodiment may be highly advantageous as for example a high-power three-phase busbar for energy distribution in high-power electrical systems, which can be manufactured in a single unit by additive manufacturing, and can be mounted and replaced as a single unit.

In an embodiment, said electrical conductor assembly has a resonance vibration frequency of at least 5 Hz, for example at least 20 Hz, for example at least 30 Hz, for example at least 70 Hz, for example at least 150 Hz for example at least 300 Hz, for example at least 500 Hz.

The electrical conductor assembly is advantageously designed and subsequent manufactured so that it has a resonance vibration frequency associated with relative motion between the first end second ends that is does not coincide with a natural frequency of the electrical system in which it is included. This is to avoid vibrations initiated by natural frequencies from such electric system or mechanical system. An example of a mechanical system is a wind turbine which may have a natural frequency of, for example, around 5Hz.

In an embodiment, said electrical conductor assembly is a high-power electrical local connecting busbar.

The present invention is particularly advantageous for electrical busbars designed for high-power electrical systems, e.g. from 10kW and up, such as 22 kW, 50 kW, 110 KW, 150 KW, 225 KW, 300 kW, 350 kW, 500 kW,800 kW,1 MW,2 MW, 3 MW, or even higher, such as e.g. 5 MW or 10 MW systems, with voltages of e.g. 110V, 230V, 400V, 690V, 800V, 1000V, 1500V, 6 kV or e.g. 10 kV, and currents from e.g. 16 A, 32 A or 64 A, to several hundreds, e.g. 100 A, 200 A or 500 A, or even thousands, e.g. 1000 A to 4000 A. By local connecting busbar is referred to busbars for local connections inside such a high-power electrical system, e.g. contained inside an electrical cabinet housing a power converter, inverter, transformer, generator, electric motor, breaker, high-power battery system, battery charger, or similar power systems, possibly including capacitors, reactors or inductors, power resistors, dump loads, etc.

Non-limiting examples of such electrical installations/systems include energy facilities such as grid components such as substations with grid support, voltage regulation, power to x plants, etc., energy generating systems such as wind turbines, wind farms, solar plants, etc., electric installations in a private homes and industry, industrial machines, household appliances, etc. and means for transportation such as airplanes, heavy duty vehicles, light duty vehicles such as automobiles, trains, ships, etc.

In a high-power electric system, the busbars may be spaced apart and/or isolated from each other with greater distances than what is possible e.g. in an electrical motor. Further, the cross-sectional area of a current path through a busbar according to the present invention is larger than the cross-sectional area of e.g. a winding of an electric motor. This may be true both with respect to a cross-sectional area at a given point of the busbar and over a distance of e.g. 20 cm or 30 cm in the longitudinal direction of the busbar and physical dimensions. Busbars of a high-power installation or system typically require fastened to a structure comprising the system for every 25-35 cm. Fastening may be achieved with bolts screwed into a support structure such as an electric cabinet or by clamping to the support structure. The busbars need to be electrically insulated from the support structure. In such high-power installations where the primary aim of conductors is to distribute electric energy to components, the magnetic field around a busbar of the present invention is not as important as it is e.g. around a winding of an electrical motor. Thus, since the magnetic field is not the main purpose for manufacturing the electrical busbar for a high-power installation the busbar is typically not designed to have a certain magnetic field when conducting current.

Manufacturing a high-power electrical local connecting busbar by an additive manufacturing process is advantageous in that additive manufacturing is suitable for manufacturing complex shapes and is thus advantageous to employ for manufacturing of electrical busbars where these are used in narrow spaces such as in an electrical cabinet. Particularly, geometrical features of the electrical busbar, such as individual conductor branches, outgrowths, recesses, internal structures, etc. may be directly manufactured additively. Thus, using additive manufacturing for manufacturing an electrical busbar of a high-power converter or other high-power appliance is advantageous since it may permit tailoring the geometry of the electrical busbar to the conditions/design of the high-power converter and/or the electrical cabinet comprising the high-power converter or appliance.

Hence, a converter or other appliance according to the present invention comprising an at least partly insulated electrical busbar manufactured by an additive manufacturing process is advantageous in that weight and cost of materials may be reduced due to less material being used for the electrical conductors. Further, cooling of the converter or appliance is improved in that surface area of the electrical busbar can be increased and the electrical busbar can be manufactured with internal cooling channels. Further, assembling of the converter or appliance may be faster due to a reduced number of connections of electrical busbars and to more flexible electrical busbars compared to known busbars. These effects may further all contribute to a more compact design of a power converter or other appliance.

Further, the electrical busbar may be designed to improve airflow from an air inlet to an air outlet of an electric cabinet. In fact, the electrical busbar may be designed with a geometry that is guiding air flow or other cooling fluid flow in a predetermined direction. A predetermined direction may be towards a heat sink, a connection between busbar and component, an opening to an internal channel of the busbar, etc.

The invention relates to an electrical system comprising one or more electrical components connected to one or more electrical conductors, at least one of the electrical conductors being an electrical conductor assembly comprising an electrically conducting component and an electrically insulating component, at least one of which is manufactured by additive manufacturing.

Electrical systems comprise electrical components connected to conductors between the components and/or between the components and a power supply or an output. Advantageously, the present invention provides for an electrical conductor assembly, such as an at least partly insulated busbar, serving the purpose of electrical connection.

The properties and features of the electrical conductor assembly of the electrical system correspond to the above description of an electrical conductor assembly such as an at least partly insulated electrical busbar of the invention and are further elaborated herein.

In an embodiment, the electrical system is a high-power electrical system and the electrical conductor assembly is a high-power electrical local connecting busbar.

High-power electrical systems and at least partly insulated high-power electrical local connecting busbars are described above, and such busbars with insulation by additive manufacturing is particularly advantageous in such a configuration, where insulation can be customized to the specific applications.

In an embodiment, the electrical conductor assembly is the electrical conductor assembly according to any of the embodiments of electrical conductor assemblies described above.

In an embodiment, the electrical system is comprised in an electrical cabinet or panel.

In an embodiment, the electrical system comprises a power converter, such as an AC-DC converter, a DC-AC inverter, an AC-DC-AC converter, a frequency control driver, a battery charger, etc.

In an embodiment, at least one of the one or more electrical components is a power module, preferably a switch mode power module, such as an insulated-gate bipolar transistor IGBT power module or a metal-oxide-semiconductor field-effect transistor MOSFET power module, etc.

Power modules, in particular switch mode power modules, are highly useful in converter applications of all sorts. MOSFET power modules may be preferably for high frequency switching, but have lower power capability than IGBT power modules. Conversely, IGBT power modules are highly advantageous for high-power, lower switching frequency applications.

In an embodiment, the electrical system is a three-phase electrical system.

In an embodiment, the electrical system comprises at least three of said electrical conductor assembly.

The invention relates to a method of manufacturing an electrical conductor assembly, comprising the steps of assembling an electrically conducting component and an electrically insulating component, characterized in that the method comprises manufacturing at least one of the electrically conducting component and the electrically insulating component by additive manufacturing.

In an embodiment, said assembling comprises building said electrically conducting component and said electrically insulating component concurrently by multi-material additive manufacturing.

Complex electrical conductor assemblies requiring insulation may advantageously be produced by multi-material additive manufacturing, where an electrically insulating material and an electrically conducting material are applied alternatingly or simultaneously to form the desired electrical conductor assembly, thereby enabling creation of conductor assemblies that would not be possible to obtain as one single piece before. For electrical conductor assemblies where one of the components are not necessary to manufacture by additive manufacturing, it may anyway be beneficial to utilize multi-material additive manufacturing to achieve the complete assembly in one process step. Some of the possible technologies for multi-material additive manufacturing are mentioned above.

In an embodiment, wherein said assembling comprises manufacturing said electrically conducting component by additive manufacturing and providing said electrically insulating component at least partially onto a surface of said electrically conducting component by surface treatment.

Advantageously, a 3D-printed electrically conducting component may be coated or otherwise provided with electrically insulating material to form the electrical conductor assembly. The surface treatment providing the electrically insulating component may apply to the entire surface of the conducting material, possibly except the terminals thereof, or it may be applied partially, for example at selected portions of the conductor surface, for example where a sufficient safety clearance air gap to nearby conducting parts is not feasible, or to reduce the risk for operators or service technicians.

Surface treatment, as used here and elsewhere herein, may comprise any technology or process of applying or creating a substance on a surface of another substance. Surface treatment may for example comprise coating with a separate substance, where examples of suitable coating methods comprise painting, spraying, dipping, powder coating, plating, shrinking, physical or chemical vapor deposition PVD/CVD, low temperature arc vapor deposition LTAVD, ion beam assisted deposition IBAD, etc. Surface treatment may alternatively or in addition comprise conversion coating, where a surface is modified to achieve different properties, where examples of suitable conversion coatings comprise chromating, phosphating, anodizing, hard anodizing, patination, plasma electrolytic oxidation PEO, etc.

The electrically conducting component may for example be provided with an electrically insulating component at select portions by thermal spraying of ceramic coating, powder coating or dip coating with thermoplastics, painting with non-conducting paint, cold spray additive manufacturing with a polymer, etc.

In an embodiment, wherein said assembling comprises providing said electrically insulating component and manufacturing said electrically conducting component by additive manufacturing onto a surface of said electrically insulating component.

The electrically insulating component may be provided from, e.g., a molding process or any other manufacturing technology for insulating components, including a separate additive manufacturing process, e.g. stereolithography SLA. The electrically insulating component may for example be in the form of an elongated sheet or slab, a U-shape profile half pipe, etc., onto which the electrically conducting component can be created by additive manufacturing to form together an electrical conductor assembly having insulation on at least one side. The pre-manufactured electrically insulating component may also be a complex geometry, allowing for more complex insulation in the final assembly.

In an embodiment, wherein said assembling comprises manufacturing said electrically insulating component by additive manufacturing and providing said electrically conducting component at least partially onto a surface of said electrically insulating component by surface treatment.

Advantageously, a 3D-printed electrically insulating component, e.g. made by FDM, SLA or SLS, may be coated or otherwise provided with electrically conducting material to form the electrical conductor assembly. The surface treatment providing the electrically conducting component may apply to the entire surface of the insulating material, or it may be applied partially, for example as conducting bands along the elongation of the insulator surface. The application of the electrically conducting component to the electrically insulating component should achieve one or more unbroken conductive paths between at least the first and second terminals in order to enable conduction of electrical current.

The description of surface treatment described above also applies here, with examples of surface treatment to provide an electrically conducting component comprising powder coating or painting with a copper or aluminum based coat, cold spray additive manufacturing with electrically conducting alloys, etc.

In an embodiment, wherein said assembling comprises providing said electrically conducting component and manufacturing said electrically insulating component by additive manufacturing onto a surface of said electrically conducting component.

The electrically conducting component may be provided from, e.g., extrusion or a molding process or any other manufacturing technology for conductors, including a separate additive manufacturing process, e.g. selective laser melting SLM. The electrically conducting component may for example be in the form of an elongated sheet or slab, a bar or rail, etc., onto which the electrically insulating component can be created by additive manufacturing to form together an electrical conductor assembly being at least partly insulated. The pre-manufactured electrically conducting component may also be a complex geometry, such as web-like or bionic, onto which insulation is applied by additive manufacturing to form the final assembly. The application of electrically insulating component by additive manufacturing may for example be achieved by fused deposition molding, cold spray additive manufacturing, stereolithography, etc.

In an embodiment, wherein said assembling comprises manufacturing said electrically insulating component by additive manufacturing to form a channel, and applying said electrically conducting component in said channel in fluid form.

Using a fluid form, preferably liquid, of an electrically conducting component may be advantageous in facilitating filling out the channel in the electrically insulating component to form a continuous electrically conducting component between the first and second terminals. The material for the electrically conducting component may be selected to solidify once inserted, or it may stay fluid. An electrically conducting component not only applied in fluid form but also utilized as conductor in fluid form may be pumped or otherwise made to flow through the channel while conducting, thereby allowing cooling of outflowing conductor fluid, and feeding the channel with cooled conductor fluid. The fluid electrically conducting component may for example be directed through a heat sink or heat exchanger before being re-introduced into the channel. Fluids that can be used as conductors in liquid form, in a non-limiting example, comprise mercury, gallium-indium alloy, gallium-indium-tin alloy, and electrolytes.

In an embodiment, further comprising solidifying said electrically conducting component to solidify in said channel.

Utilizing the 3D-printed electrically insulating component as a mold to receive a fluid conducting material and allowing it to solidify in the channel in the insulation provides for interesting opportunities with respect to achieving conductor shapes. As long as it is avoided to trap air in the mold, the conducting material will form a well-established conductor once solidified. This embodiment may provide an alternative to manufacturing the conducting component by, e.g., metal 3D-printing. In an embodiment the channel is not a closed pipe, but rather one or more open grooves in the surface of the insulating component, in which the fluid electrical conductor material can run.

In an embodiment, said electrically conducting component comprises a first material and said second component comprises a second material different from said first material.

In an embodiment, said first material is selected from the list of copper, aluminum, silver, gold, tin, steel, mercury, gallium, electrolyte, or alloys or combinations thereof.

In an embodiment, said second material is selected from the list of polymers, ceramics, thermoplastics, glass reinforced plastic, rubber, glass, wood, paper, oil, deionized water, or combinations thereof.

In an embodiment, the electrical conductor assembly is the electrical conductor assembly according to any of the above-described electrical conductor assemblies.

### THE DRAWINGS

Various embodiments of the invention will in the following be described with reference to the drawings where:

FIGS. 1a-1c illustrate various concepts of electrical conductor assemblies partly or fully manufactured by additive manufacturing,

FIG. 2 illustrates a method of manufacturing an electrical conductor assembly,

FIG. 3a-3b illustrates a perspective view and a cross section of a partial electrical conductor assembly according to an embodiment of the invention,

FIG. 4 illustrates an electrical conductor assembly according to an embodiment of the invention,

FIG. 5 illustrates a non-limiting, simplified example of a dual-material additive manufacturing equipment 60 for use in an embodiment of the invention,

FIG. 6 illustrates an embodiment of an electrical conductor assembly according to the invention,

FIG. 7 illustrates an embodiment of a separate additive manufacturing of an electrically insulating component in an embodiment of the invention,

FIGS. 8a-8c illustrates an embodiment where the electrical conductor assembly 1 forms a helical coil 1,

FIGS. 9-10 are alternative embodiments of FIGS. 3a, 3b and 4,

FIG. 11 illustrates a multi-phase electric conductor assembly according to an embodiment of the invention, and

FIG. 12 illustrates an embodiment of a high-power electric system of the invention.

### DETAILED DESCRIPTION

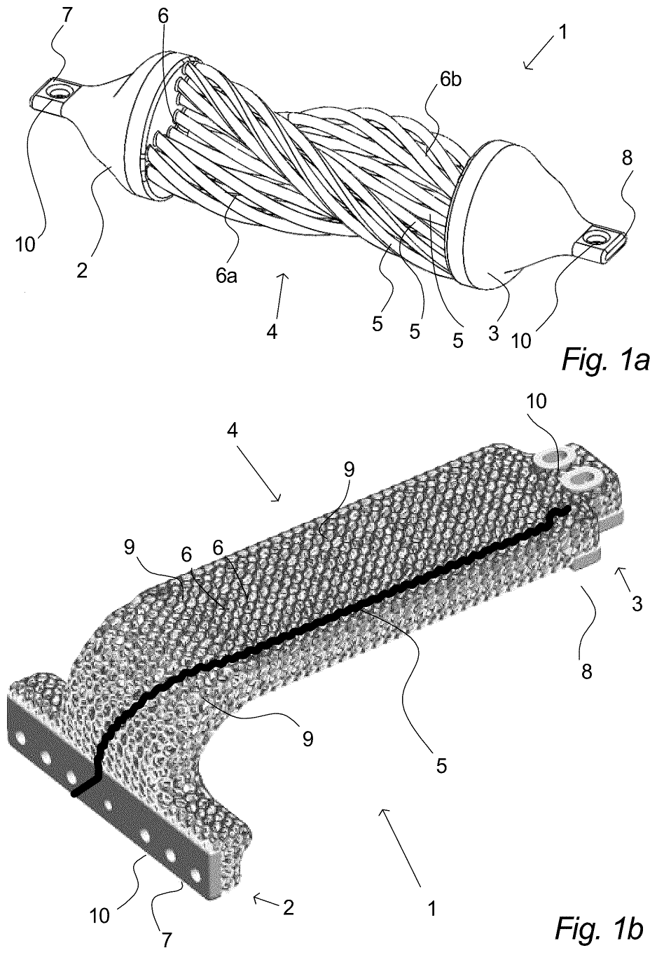

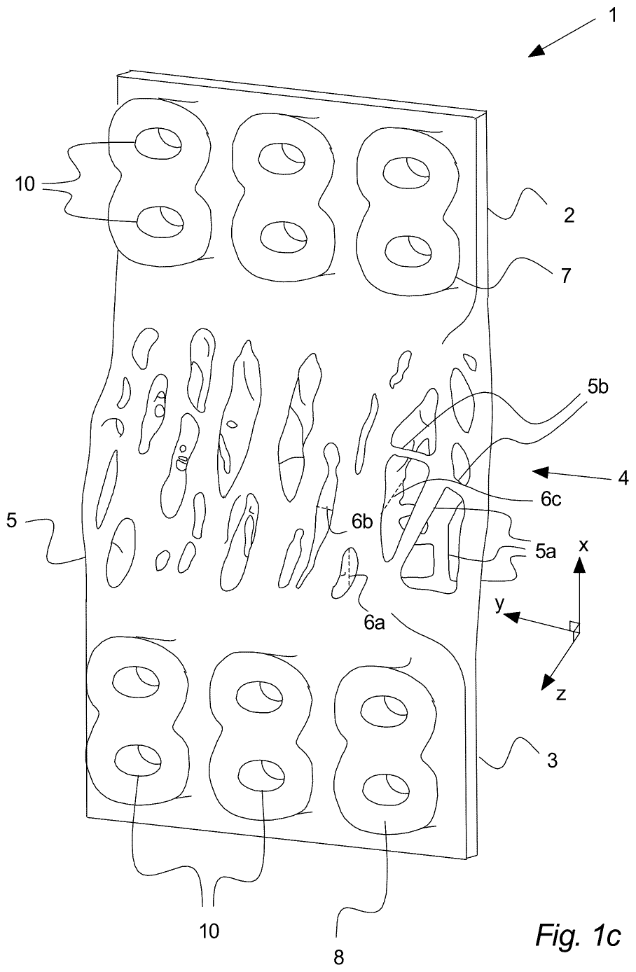

FIG. 1a-1c illustrates various embodiments of an electrical conductor assembly 1 according to the present invention, also referred to simply as electrical conductor.

FIG. 1a illustrates an electrical conductor 1 having a twisted geometry/design. The electrical conductor 1 comprises a first end 2 and a second end 3, where the second end 3 being distal to the first end 2 and spaced apart from each other by a middle segment 4.

The middle section 4 in this particular embodiment comprises a plurality of conductor branches 5. In this particular embodiment the individual conductor branches are spaced apart by air gaps 6 both in the longitudinal and 6a transversal direction 6b of the electrical conductor 1. This twisted design of the conductor branches adds flexibility to the conductor 1 and thus the ability to absorb vibrations. Further, the design is lightweight and easy to mount.

In this particular embodiment, the first end 2 comprises a first terminal 7 and the second end 3 comprises a second terminal 8. The first and second terminals 7, 8 may comprise one or more terminal holes 10 for connecting the electrical conductor 1 to other electrical components. The electrical conductor 1 is configured to support conductance of an electric current between the first and second terminals 7, 8.

Each of these two terminals 7, 8 may, via terminal holes 10, clamps, plugs or other electrical connection means, for example be galvanically coupled to terminals, busbars, components (such as breakers, contactors, power modules, reactors, etc.) and other electrical conductors according to the present invention, etc. of an electrical installation. Typically, the electrical conductor 1 and thus the terminals, busbars, components, etc. to which it may be connected would be comprised by an electric box i.e. located inside an enclosure such as a panel, cabinet, etc.

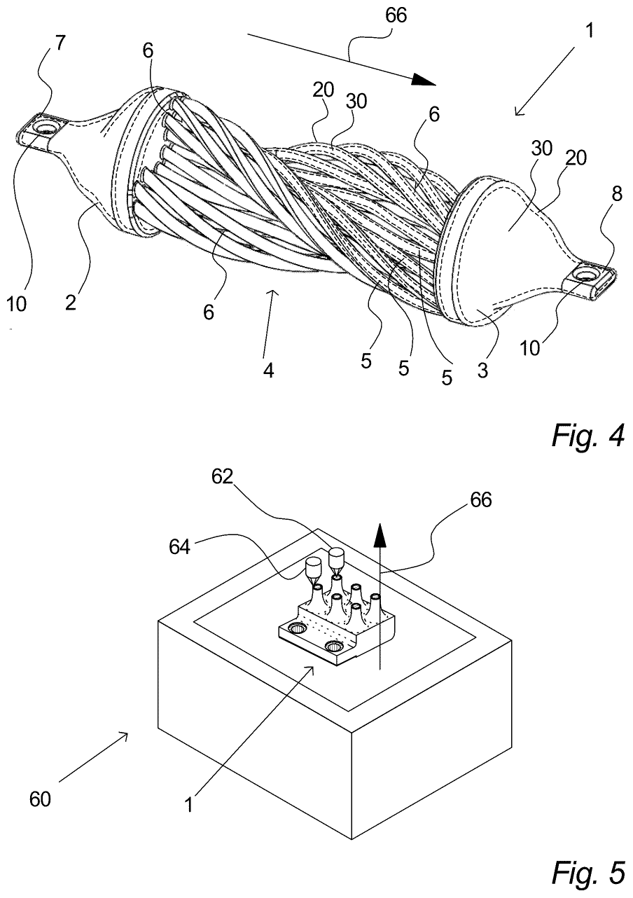

In various embodiments, the electrical conductor 1 may have several first ends 2, several second ends 3, several first terminals 7, and/or several second terminals 8. The electrical conductor assembly 1 is described in further detail with reference to FIGS. 4 and 10.

FIG. 1b illustrates an electrical conductor 1 having a web-like or lattice-like geometry/design. As the electrical conductor 1 illustrated in FIG. 1a, the electrical conductor illustrated in FIG. 1b comprises a first end 2 and a second end 3 separated by a middle section 4. The first end 2 may comprise a first terminal 7 and the second end 3 may comprise a second terminal 8. The first and second terminals 7, 8 may comprise one or more terminal holes 10 for connecting the electrical conductor 1 to other electrical components.

Between the two terminals 7, 8 conductor branches 5 in a web-like structure extend (only one is highlighted). These conductor branches meet and branch off in a plurality of intersection points 9. Note that the first and second ends 2, 3 are also partly manufactured as a web-like design as the middle segment 4. Also note, that the first and second terminals 7, 8 comprise more than one terminal hole 10. The terminal holes 10 of the terminals 7, 8 is made in a part of the ends 2, 3 which has non-perforated surface i.e. a surface different from the web-like surface of e.g. the middle segment 4 of the electrical conductor in this particular embodiment. The planar contact surface of the terminals 7, 8 around the terminal holes 10 is preferred to provide a connection surface to another flat surface with as little resistance as possible and sufficiently strong contact surface between bolt/nut and electrical conductor 1.

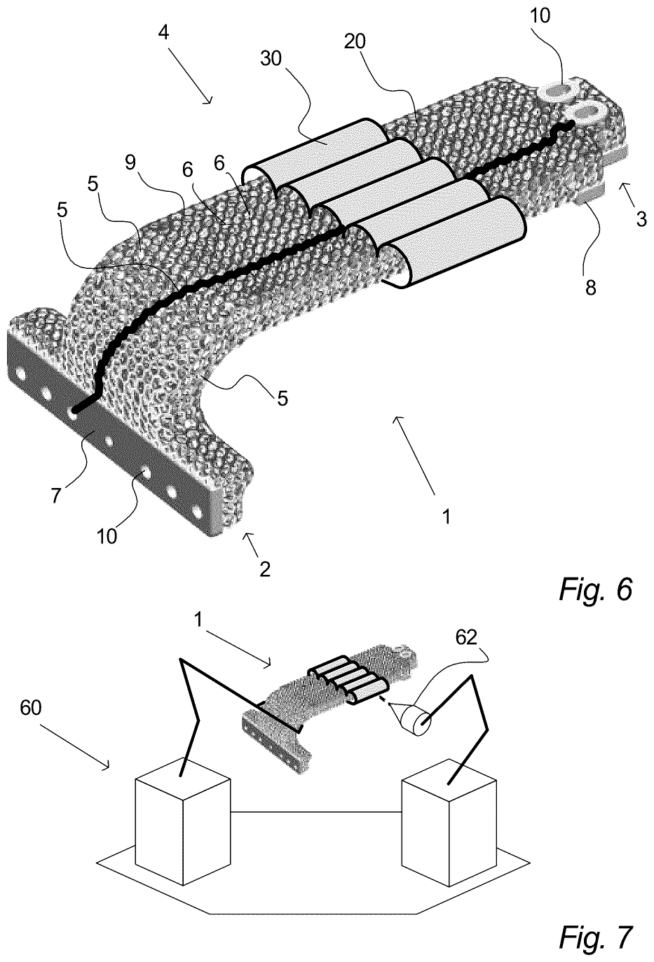

The electrical conductor assembly 1 is described in further detail with reference to FIG. 6.

FIG. 1c illustrate an electrical conductor having a bionic geometry/design. As the electrical conductor 1 illustrated in FIG. 1a and 1b, the electrical conductor illustrated in FIG. 1c comprises a first end 2 and a second end 3 separated by a middle section 4. The first end 2 may comprise a first terminal 7 and the second end 3 may comprise a second terminal 8. The first and second terminals 7, 8 may comprise one or more terminal holes 10 for connecting the electrical conductor 1 to other electrical components.

The middle segment 4 in this embodiment is of a so-called bionic design, preferably achieved as a computer generated design. Such computer-generated design is provided based on input to a computer program controlling an additive manufacturing machine/process or able to export data to a controller of an additive manufacturing machine/process such as from a user or another computer. Input may include dimension, maximum current to be conducted, required strength, maximum deflection (elastic or plastic), etc. As the electrical conductor illustrated in FIG. 1b, the electrical conductor of this particular embodiment comprises both longitudinal conductor branches 5a and transversal conductor branches 5b. It is noted, that together the conductor branches 5a, 5b forms a transversal conductor branch outgrowth i.e. if seen in a side view, the electrical conductor 1 of FIG. 1c would be thicker at the middle section 4 than at the ends 2, 3. The conductor branches 5 are spaced apart in space by air gaps 6 in both X (6a), Y (6b) and Z (6c) directions. Further note, that the terminals 7, 8 are designed with a planar surface to obtain best possible contact with a component having a planar surface, to which the electrical conductor 1 is to be connected to, such as clamped against, via for example bolt and nuts. Also note, that independent from the geometry of the ends 2,3, the terminals 7,8 are aligned/raised so that the contact surface for, e.g., all three terminals 7 are in the same plane.

The above embodiments of an electrical conductor 1 all feature airy geometries having air gaps 5 between conductor branches 6. The electrical conductor 1 of the present invention may in other embodiments feature other airy geometries such as web-like, gyroid-like, lattice-like, etc., as described in more detail herein, which in various embodiments may provide improved cooling, reduced material consumption, improved flexibility, and/or other advantages described in more detail herein. The term ‘-like’ is used in connection with gyroid-like, lattice-like, etc., to emphasize that it is an airy geometry resembling the named structure, rather than a specific systematic structure, that is relevant in preferred embodiments of the invention.

It should be noted that the three different designs of electrical conductors of the present invention illustrated in FIG. 1a-1c is not limiting for the designs or geometries or structures that is possible to manufacture according to the present invention. Other designs that are possible to represent digitally and transfer to an additive manufacturing device and thus manufacture by additive manufacturing is considered to fall with the scope of the present invention. This includes designs having plane surfaces with internal ducts, manufactured by different materials, manufactures with protrusions or recesses, manufactured to have auxiliary functions beside conducting current, etc. Particularly, high-power conductors are advantageous to manufacture according to the present invention.

Note that embodiment of the invention, such as the above-described electrical conductors, may comprise further terminals 7, 8 between the ends 2, 3, which are not illustrated. Also note, that a plurality of the illustrated electrical conductors 1 may be connected to form a complete electrical conductor. In this case the first and second end 2, 3, is referred to as the ends of the complete electrical conductor which may comprise terminals 7,8 and e.g. terminal holes 10 for connecting the complete electrical conductor to other components. Between these first and second ends 2, 3 of the complete electrical conductor, terminals 7, 8 of a plurality of electrical conductors as illustrated may be connected.

The cross-sectional area of the conductor/conductor branches can be exploited to its full potential in an electrical conductor of the present invention. The conductor is designed and manufacture to have a cross-sectional area that is able to comply with requirements to current to be conducted without have excess of material used. The design of the present conductor may not have surplus material which is not used for conducting current when nominal current is supplied e.g. to a 1400 A power module. If extra material is used, this is used for cooling the conductor or a safety margin. The amount of such extra material can be determined relatively precise by the software which is used to design the conductor. As a rule of thumb, the larger surface for cooling, the higher amps is possible to conduct. The design software may be able to put weight on amps, cooling properties (cooling medium, surface, etc.), frequency of the current when designing the geometry of the conductor, etc. when designing the conductor. Accordingly, a conducting cross-sectional area of a conductor as illustrate in FIG. 1b may be 80 mm2 may in certain embodiments be sufficient to conduct a current of 1300 A due to the airy design allowing a very advantageous cooling. In fact, tests have shown that the temperature of a conventional massive busbar with a conducting cross-sectional area of 516 mm2 conducting 1300 A increases to a temperature where neighboring components of plastic is in risk of melting.

Hence, it should be noted that the conductor may be designed and subsequently manufactured so that a percentage of the cross-sectional area of the electrical conductor e.g., above 80% such as between 90% and 100% is used to conduct current during normal operation. This is in contrary to known massive busbars that does not exploit the material in its center to conductor current. This is at least true for most frequencies of currents conducted in high-power systems including renewable systems, vehicles and the like.

The high percentage of utilization of cross-sectional area for conducting current compared to known massive conductors is possible to obtain in that the conductor of the present invention and thus the individual conductor branches because they are designed with a cross-sectional area that sums up to be able to conduct a current of a given frequency. Further, the material reduction is also made possible because of the possibility of cooling also inside the conductor. In fact, a conductor branch may along most of its length, in some embodiments along all of its length, be cooled from all angles i.e. a 360° cooling of the conductor branches is possible.

As mentioned, a conductor of the present invention may form an airy geometry which depending on the kind of airiness may not facilitate a secure or robust platform or structure for fastening the conductor e.g. to the electric cabinet. Accordingly, in proximity of through-holes for fastening the conductor or through-holes, e.g. terminal holes, for connecting the conductor to components or other conductors, the geometry of the conductor may not be airy. Preferably, around a through-hole the density of the conductor is higher or more concentrated to form an, e.g., planar surface and thereby provide the best possible preconditions for conducting current between two parts of a joint and to distribute the force required to fastening a conductor in the joint or to a support structure. Hence, a through-hole may be designed as a cylinder through which a bolt may pass through and with planar upper and lower parts extending from the periphery of the cylinder to facilitate the force and/or current distribution in the joint. Other mounting and/or terminal points may be preferred in some embodiments, such as flanges, protrusions, plugs or sockets, etc., with or without through-holes, but with the same consideration of ensuring sufficient robustness and stability of the electrical conductor for the intended mounting or connection method. The through-holes could be 6 mm, 8 mm, 10 mm or 12 mm in diameter.

It should be mentioned that terminals for electrical connection may be positioned at or between the ends of an electrical conductor. Thus, in principle, a conductor may be manufactured by an additive manufacturing process and when the first end and first part of the middle segment is manufactured these may be rolled onto a conductor holder as the middle segment is continued to be manufactured. Alternative, the conductor is guided out of the printing areas e.g. by a conveyer belt as the conductor is manufactured. This may result in a long conductor with two ends. Either during manufacturing or after, terminals may be made in the conductor and also after manufacturing, the conductor may be cut into desired lengths. In this way, terminals may be manufactured or provided either at the ends or between the ends of the conductor.

The term monolithic is in this description used to describe the geometry or structure of an electrical conductor according to the present invention. Such conductor is preferably manufactured by an additive manufacturing process and thereby, it is manufactured as a single piece, unit or block from one end to the other or at least one end and a middle segment is manufacture as a single piece. Such conductor may thus be formed from a single material as a single piece, unit or block where its one or more ends are monolithically formed with a middle segment connecting the one or more ends i.e. monolithically formed should be understood as made in one continuous process with no need for additionally adding one part to another I.e. one or more ends are manufactured together with the middle segment as one unit with no connections such as welding, soldering, or by any clamping or fastening means, except for the type of micro binding intrinsic to the particular additive manufacturing technology utilized, such as, e.g., layer-by-layer melting, sintering, liquid binding, spraying, etc. With this said, it should be mentioned, that it is possible to add additional elements such as terminals, cooling fins, etc in a post manufacturing process e.g., by a cold spray process.

Put in another way a conductor of the present invention is the result of a process forming the conductor in one structure, a conductor composed of an electrically conductive material without joints or seams and thus constituting a conductor as a rigid whole exhibiting a rigidly fixed uniformity. To such conductor it is possible to connect additional conductors via terminals and thereby branch off one current path to two or more current paths or vice versa.

It should be mentioned that the conductor may be manufactured from more than one type of material. In this situation, the conductor could be said to be polylithic. The term polylithic should in this context be understood as a geometry or structure of an electrical conductor that is manufactured in one piece as a monolithic structure, as described above, where the conductor is manufactured from two or more materials. Hence, a polylithic conductor of the present invention is a conductor resulting from a process forming the conductor in one structure where the process is using two or more different materials. Such two or more materials may be a combination of electrical conductive or non-conductive materials.

In most embodiments, the electrical conductor 1 is designed to comply with high voltages i.e. voltages above 24V such as 110V, 230V, 400V, 690V, 1000V, 1500V and up to kV systems. just to mention a few voltage levels of an electrical installation in which the electrical conductor 1 of the present invention would be suitable. In terms of current, an electrical conductor 1 according to the present invention may be designed to conduct several hundreds of amps (16, 32, 64, and so on up to 100, 200 and so on up to e.g. 900 A) up to a couple of thousand amps (1000 A-3000 A). Electrical conductors may be designed to conduct higher currents than 3000 A e.g. by improving cooling of the conductor in combination with an increased cross-sectional area of the conducting part of the conductor.

Mentioning these voltages, it should be noted, that in principle there are no lower limits as to the voltage and current. I.e., versions of the electrical conductor may be designed to be used in, e.g., 3.3V, 5V, 9V, 12V, 15V, 20V, 24V or 48V systems, such as USB power delivery PD systems, conducting currents below, e.g., 10 A, such as 5 A, 3 A, 2.4 A, or 2 A just to mention a few examples.

Thus, the electrical conductor 1 of the present invention is suitable for use in almost any type of electrical installation. This includes everything from low voltage to high voltage AC and or DC systems where transfer/conducting of current or communication signals is needed.

The present invention is particularly advantageous for electrical busbars designed for high-power electrical systems, e.g. from 10 kW and up, such as 22 kW, 50 kW, 110 KW, 150 KW, 225 KW, 300 kW, 350 KW, 500 kW, 800 kW,1 MW, 2 MW, 3 MW, or even higher, such as e.g. 5 MW or 10 MW systems, with voltages of e.g. 110V, 230V, 400V, 690V, 800V, 1000V, 1500V, 6 kV or e.g. 10 kV, and currents from e.g. 16 A, 32 A or 64 A, to several hundreds, e.g. 100 A, 200 A or 500 A, or even thousands, e.g. 1000 A to 4000 A. By local connecting busbar is referred to busbars for local connections inside such a high-power electrical system, e.g. contained inside an electrical cabinet housing a power converter, inverter, transformer, generator, electric motor, breaker, high-power battery system, battery charger, or similar power systems, possibly including capacitors, reactors or inductors, power resistors, dump loads, etc. A system, component or conductor may be categorized as a high-power system, component or conductor if it is operating at currents in the range of 800-1000 A or higher.

Non-limiting examples of such electrical installations/systems include energy facilities such as grid components such as substations with grid support, voltage regulation, power to x plants, etc., energy generating systems such as wind turbines, wind farms, solar plants, etc., electric installations in a private homes and industry, industrial machines, household appliances, etc. and means for transportation such as airplanes, heavy duty vehicles, light duty vehicles such as automobiles, trains, ships, etc.

Accordingly, the electrical conductor may be a high-power electric conductor of a high-power electric system. In a high-power electric system, conductors may be spaced apart and/or isolated from each other with greater distances than what is possible e.g. in an electrical motor. This distance is referred to as a safety clearance and the size of it depends on the voltage differences in the system. Thus, when depending on air as isolator between an otherwise non-isolated busbar/conductor and another conductor or structure of conductive material such as a metal cabinet, the distances must be taken into account in compliance with safety regulations. It should be mentioned that air quality/pollution degree, such as humidity and particle content, may also be relevant for the distance of the safety clearance. In case a conductor is used in a high-voltage system the surface is manufactured to reduce field concentrations.

Further, the cross-sectional area of a current path through a conductor according to the present invention is larger than the cross-sectional area of e.g. a winding of an electric motor. This may be true both with respect to a cross-sectional area at a given point of the conductor and over a distance of e.g. 20 cm or 30 cm in the longitudinal direction of the conductor and physical dimensions.

Current conducting busbars of a high-power installation or system is typically fastened to a structure comprising the system for every 25-35 cm. If the current is conducted by cables, the distance between cable fasteners may be even smaller. The fastening may be made by screwing bolts into a support structure such as an electric cabinet or by screwing clamps to the support structure which is then closed and thereby fastening the cable/busbar. The conducting cables/busbars are of course insulated from the support structure.

In such high-power installations where the primary aim of conductors is to distribute electric energy to components, the magnetic field around a conductor of the present invention is not as important as it is e.g. around a winding of an electrical motor. Thus, since the magnetic field is not the main purpose for manufacturing the electrical conductor for a high-power installation the conductor is typically not designed to have a certain magnetic field when conducting current.

Further, again comparing to e.g. a winding of an electrical motor, a conductor of the present invention would as a general rule be designed with a surface area that is as large as possible to optimize the possible advantages of the invention as described herein. Depending on the purpose of the conductor, the surface may for example be designed for conducting current, conducting current and heat dissipation or heat dissipation. Thus, even though all portions of a conductor of the invention may comprise an electric conductive material, not all portions are necessarily used for conducting current through the conductor. In general, the available area around a conductor is exploited to expand the surface of the conductor for one of, for example, the heat dissipation or current conducting purposes, or other described purposes such as improved flexibility, reduced material consumption, air guidance, etc. The available area is limited by safety clearances to other conductors of different phases having different voltage levels, grounded structures such as elements of an electric cabinet, etc.

An example of a portion of a conductor that is primarily used for non-conducting purposes such as heat dissipation or air guidance, is an outgrowth from the surface of the conductor which is not connected at the distal end of where it is growing from the surface of the conductor. Such outgrowth or protrusion may for heat dissipation purposes preferably comprise some kind of bionic design with airgaps between branches, possibly with a continuous surface towards a direction of air flow for air guidance purposes. Such portions would be referred to as conductor branches if these were part of the middle segment conducting current form one end to the other. Such outgrowth may in principle take any form or geometry exploiting the free space around the area as long as safety clearance distances are maintained. In such examples, the fraction of current conducted by the surface area of the outgrowing conductor portion is very small if not zero.

An example of a portion of a conductor that is only used for conducting a current may in principle not be possible in that heat dissipates even from a solid block and a planar surface. What should be understood by a portion of a conductor primarily used for conducting current, is a varying structure or geometry for a middle segment of the conductor between the first and second terminals. When space is narrowed between components in an electrical system, if other conductors are to be passed, if the conductor has to pass through a current sensor or bushing, etc., the surface area of that particular portion of a conductor middle segment may be reduced to comply with available space, thereby typically increasing the conductor density to achieve a narrower outer dimension. In this example, at this particular portion of the conductor, the current conducting portion of the surface area of the conductor becomes high; possibly so high that a hot spot is created where additional cooling is required to continue to maintain a certain current conduction capacity. Hence, this is an example which may benefit from a combination of the conducting portion with an outgrowth portion, as described above, e.g. on each side of the narrowed part of the conductor. In this way, heat generated at the narrow space can be dissipated via the nearby outgrowths, e.g. further in combination with internal cooling channels.

An example of a portion of a conductor that is used for both heat dissipation and current conduction is a middle part between the terminals, with an airy design or geometry. In such example, the surface areas having the main purpose of dissipating heat and conducting current, respectively, may be the same or close to be the same. This is due to a geometry comprising conductor branches spaced apart from each other so that a flow of cooling air may pass freely by each conductor branch, i.e., through air gaps defined by the conductor branches. In this example the current conducting surface area is large compared to traditional conductors/busbars and windings e.g. of an electric motor. Another difference between a motor winding and a conductor of the present may be found in the circumference of the conductor. The limited space inside a motor obviously limits the circumference of the winding. This is not the case to the same extent e.g. in an electrical cabinet comprising a conductor of the present invention. More space is available and thus the circumference can be made larger leading to an airy design with airgaps for increased cooling. Further, the cross-sectional area of the individual conductor branches of a conductor according to the present invention is often lower than the cross-sectional area of a motor winding.

As mentioned, the electrical conductor 1 may comprise first and second ends 2, 3 spaced apart by a middle segment 4. One complete or final electrical conductor may comprise a plurality of interconnected electrical conductors 1 of the types illustrated/described above. In such embodiment the illustrated electrical conductors may be used as sections of the final or complete electrical conductor. Thus, a final or complete electrical conductor may comprise first and second ends 2, 3, with a plurality of first and second terminals 7, 8 at the ends or between them, e.g. with terminal holes 10 for connecting a plurality of the illustrated/described electrical conductors to form the final or complete electrical conductor.

The terminals 7, 8 may comprise one or more terminal holes 10 or other structures for connecting the electrical conductor 1 to other electrical conductors such as busbars, cables or the above-described electrical conductors, electrical components such as breakers, power modules, batteries, etc.

Alternatively, in an embodiment, one or both of the terminals 7, 8 of the electrical conductor 1 form part of an electrical component as an alternative to being provided as freely connectable locations at the conductor 1.

A terminal 7, 8 may in a simple embodiment comprise a terminal hole 10 through the terminal 7, 8. Via such hole, a bolt can go through and continue through a component with which the electrical conductor 1 is to be connected. The electrical conductor and the component are then clamped together via a nut and the bolt.

Alternatively, a terminal 7, 8 may be a click terminal that is either designed to receive a click part form a component to which the electrical conductor is the be connected or designed with a click part that is to be inserted into such other components.

Alternatively, a terminal 7, 8 at an end 2, 3 of the electrical conductor may be manufactured with a threat which when engaging with a bolt is able to assist in clamping a component to the electrical conductor 1.

Further, it should be noted, that an electrical conductor as illustrated or a complete electrical conductor comprising a plurality of electrical conductors such as the above described may have more than one first end 2 or more than one second end 3. Hence, one end of an electrical conductor 1 may branch off in e.g. three terminals each with a terminal hole. This may be advantageous in that the geometry of the electrical conductor is then designed specifically to the component to which it is to be connected. Branching off the ends into several terminals may also improve heat dissipation capacity at the possibly denser terminal portions, improve electrical connection between the conductor and components, and avoid additional connection pieces or shunts in order to connect adjacent components to a common conductor.

The middle segment 4 may comprise one, but preferably a plurality of conductor branches 5. The conductor branches 5, like the end segments 2, 3, are at least partly made of an electric conductive material such as copper or aluminium or alloys thereof, enabling the electrical conductor 1 to conduct a current between its terminals 7, 8. The design of the conductor branch(es) 5 may be optimized according to a specific purpose such as cooling, material consumption, flexibility (control in a particular direction), footprint, etc. Thus, depending on which parameter(s) the electrical conductor 1 is designed according to, the conductor branches may be designed as longitudinal cylinders (or other geometries such as oval, square, etc.), web, bionic, gyroid-like design, lattice-like design, branch-like design, or sponge-like design, coil or solenoidal designs, spirals, etc.

Thus, the electrical conductor may have a perforated surface, a non-perforated surface, a massive structure or a structure with internal channels optimizing the electrical conductor according to skin-effect and cooling, etc.

Two or more conductor branches 5 may meet in an intersection point 9 and two or more conductor branches 5 may branch off from an intersection point 9. This has the effect, that an electrical conductor is established that maintain a desired strength (determined yield point) with a minimum of material. Among others, this may reduce the cost of the electrically conductive material and reduce the weight of the conductor. It should be mentioned that two conductor branches meeting in the intersection point 9 may be the same two conductor branches leaving that intersection point 9. Alternatively, two other conductor branches may leave the intersection point, however this may be a question of definition of a conductor branch. Further one conductor branch may branch off to a plurality of conductor branches and a plurality of conductor branches may meet and form a lower number of conductor branches.

Further, it should be mentioned that the electrical conductor 1 may be designed as a plurality of electrical conductors, e.g. as a combination of three phase conductors or as a wire harness or printed circuit board traces of a printed circuit board used for mounting in an electric panel.

At least a first end 2 and a middle segment 4, but preferably also the second end 3, of the electrical conductor 1 of the present invention are monolithically formed, since they are manufacturing from a single bulk of material, which is machined to provide the electrical conductor 1. Here bulk of material should be understood as the material such as electrically conductive material of which the electrical conductor 1 is made, e.g. a solid, powder, liquid, wire, etc. Here machined should be understood as manufactured by additive manufacturing, i.e. the electrical conductor 1 is made in one piece without any mechanical connections of the first end 2, second end 3 and middle segment 4.

Note that more than one type of material, e.g. two bulks of material, may be used to manufacture the electrical conductor. One of such two or more bulks of material may be electrically non-conductive.

Note that in some embodiments it may be necessary to manufacture the electrical conductor in more than one piece. In this situation the electrical conductor may be referred to as a complete or final electrical conductor which comprises a plurality of electrical conductors 1 as described above. This may be the case e.g. if the electrical conductor needs to be mounted in a location where it cannot be inserted unless the electrical conductor is separated in two or more pieces or if the complete electrical conductor has to be larger than what is possible to manufacture by additive manufacturing. In such situation, terminals of two electrical conductors are connected, extending the length of the middle section and thereby the current path between the first end 2 and the second end 3 and thus of the complete electrical conductor. Such connection may be prepared by designing terminal holes in the conductor where, e.g., fish plates or other joints may be fastened and thereby connecting the two middle segments.

It should be noted that the electrical conductor 1 may have a non-uniform geometry/design. The design/geometry may take any machinable/printable shape. Such shape may be optimized according to conducting current (skin effect), cooling, guidance of flow of cooling fluid, other components in a panel, resistance, power loss or current displacements, etc.

In a particular embodiment, the electrical conductor 1 may have a non-uniform diameter (measured in a transversal direction) along the lengthwise direction. A well-defined diameter may nevertheless be determined e.g. at a transversal plane at which that electrical conductor 1 has its smallest diameter.

Moreover, in an embodiment of the invention the perimeter length of the electrical conductor 1 or its conductor branch(es) 5 may vary in transversal planes at different positions in the lengthwise direction of the electrical conductor 1. The perimeter length of a given part of the middle segment may simply be measured as the sum of all lengths of perimeters of branches in a given transversal plane. Hence, the perimeter length at a given part may thus be the length of the perimeter of conductor branches measured across/perpendicular to the longitudinal direction of the electrical conductor at that part. A part of a conductor may also be referred to as a portion of a conductor and should be understood as a reference to a specific portion of the conductor such as an end or middle segment.

The perimeter length of the conductor branches 5 may be the sum of lengths of perimeters of all individual conductor branches 5. As one conductor branch may split from a stem to two or more twigs, i.e. branches of a branch, the perimeter at one part of the conductor branch may be different from one part (e.g. a twig part) to another part (e.g. a stem part). Hence, the sum of lengths of perimeters of the conductor branches may be the sum of all individual twigs or of all the individual stems. In case of multiple different possible perimeter lengths for the conductor parts along the length of the electrical conductor, the smallest perimeter length may preferably be used in calculation of current conduction capability of the electrical conductor 1.

In the same way, the cross-sectional area of an electrical conductor at a given part is measured as the sum of the cross-sectional area of all conductor branches at a given part along the length of the electrical conductor. The cross-sections at that part should be measured perpendicular to the longitudinal direction of the electrical conductor.

In an embodiment, the electrical conductor 1 may comprise one or more cooling channels, where the cooling channel may be placed inside the one or more conductor branches, transversally and/or longitudinally.

The manufacturing of the electrical conductor 1 may be done by an additive manufacturing process. Such manufacturing process may be based on, but not limited to, one of the following additive manufacturing processes: 3D printing, layer by layer printing, Wire Arc Additive Manufacturing, Fused Deposition Modeling FDM, Direct Energy Deposition, Direct Metal Deposition, sintering based processes, laser based processes, for example Powder Bed Fusion PBF, such as selective laser melting SLM or selective laser sintering SLS, cold spray additive manufacturing CSAM, binder jetting or binder jet 3D printing, etc. It should be mentioned that the actual additive manufacturing process used to print or build the electrical conductor 1 may not be important as long as the material of which the electrical conductor is built is an electrically conductive material.

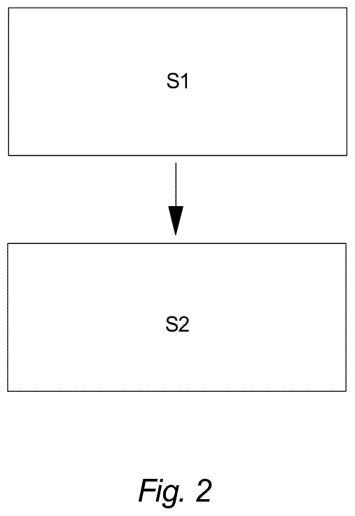

FIG. 2 illustrates method steps for machining an electrical conductor 1 according to an embodiment of the invention. The particular method relates to forming an electrical conductor with two ends or two terminals, namely a first end/terminal and a second end/terminal via a middle segment, but may be used for producing any kind of electrical conductor of the present invention.

It should be mentioned that this may include manufacturing both ends and the middle segment in one process. Hence, with additive manufacturing along the longitudinal direction of the conductor, the method may start by manufacturing, such as printing, one end, then a transition to the middle segment, possibly one or more conductor branches, then the middle segment, then a transition to the second end and finally the second end. In another embodiment, the additive manufacturing occurs transversal to the conductor's longitudinal direction, thereby for example manufacturing portions of both ends and the middle segment simultaneously, increasing the cross section with each applied layer. In another embodiment, the additive manufacturing is radial, or even arbitrary, to the conductor's longitudinal direction, for example using cold spraying CSAM or Fused Deposition Modeling FDM while rotating or freely moving either the conductor unit being built or the nozzle, or both. Preferably, the mentioned segments are manufactured in one process, e.g. as one segment is manufactured, the next segment is being manufactured. A transition part may be made between such two segments which may start or include the first segment. Similarly, the second segment may include a transition part or is connected to such transition part.

It should also be mentioned that the method could in some embodiments comprise manufacturing the middle segment and afterwards connect the end segments. The end segments could be connected while being additive manufactured or could be connected with an additive manufacturing thermal paste or glue after being made. The end segments could also be welded, glued or connected in any other way to the middle segment, e.g. by cold spraying CSAM.

An additional embodiment of the invention could be a manufacturing method that comprises two or more middle segments being additive manufactured. The two or more middle segments could be additive manufactured in the same process with the two end segments to form the electrical conductor. The two or more middle segments could also be additive manufactured separately and connected afterwards to form the electrical conductor.

The two or more middle segments could be identical or could be two differently shaped or otherwise characterized middle segments depending on where the electrical conductor should be placed in e.g., an electrical cabinet.

A transition may straightforwardly be defined as a change of size of a layer compared to a previous layer. In this way a transition may be formed as a perpendicular transition between an end segment and a conductor branch of the middle segment. Alternative, subsequent layers may change in cross-sectional area and thus form a transition as a rounded transition which may be advantageous in terms of a reduced resistance for current conducted between the ends of the electrical conductor.

A monolithic conductor according to the present invention is made from one material. One or more additional materials may be used e.g. as isolation, for heat dissipation, etc. in this case the conductor may be referred to as a polylithic conductor. No matter the number of materials, a conductor produced by additive manufacturing is produced bit-by-bit starting at a first spatial coordinate (x, y, z) and ending at a second spatial coordinate. At least when the conductor is finished the first and second spatial coordinates are electrically/mechanically connected. As mentioned several methods of manufacturing a conductor exists all including some kind of material depositing, joining or soldering to manufacture a conductor in one monolithic form.

In this document a conductor may be referred to as being manufactured layer-by-layer no matter the additive manufacturing method used. Hence, if a conductor is sliced (no matter in which orientation) and one is looking at the cross-section of the conductor it is easy to imagen that the conductor is manufactured starting with material in first point, then with material in a second point and so on. Since the conductor is volumetric i.e. has a three dimensional geometry the first point is different from the second and subsequent points at least in one of the spatial X, Y and Z directions/plans. Thus, with reference to the spatial X, Y and Z planes a conductor could be said to be built from a plurality of subsequent layers even though when manufactured all material in one plane such as X=1 and Y=0 and Z=0 is not provided as a one layer or in one layer before material in a next layer (e.g. an X=2 layer) is provided.

Hence, no matter which of the processes of manufacturing a three-dimensional object such as a conductor that is used, it can be said that the conductor is manufactured layer-by-layer even though some of these manufacturing processes are based on deposited, joined or solidified with material being added together in areas, lines, pointwise, etc. This is because no matter the additive manufacturing process the conductor is manufactured one point after the other. A plurality of points in the same plan (e.g. X=3) is considered one layer also if they are not physically connected in this plane. And when all points of this layer are added, points of the next layer (e.g. X=4) is added to the points in the X=3 layer. As mentioned, a layer may be defined in any of the planes of a spatial Cartesian coordinate system.

Alternatively, the ends may be separate segments that are connected via the middle segment. The middle segment may be printed, and during the manufacturing of the middle segment it may be attached to the ends such as printed, heated, glued or the like onto the ends. The middle segment may be joined to the ends by means of welding, printing, soldering, etc.

It should be noted that the ends may comprise terminals for connecting the electrical conductor to other electric parts/conductors/windings of an electric system. Such terminals may be manufactured like the rest of the electrical conductor by additive manufacturing i.e. monolithically formed with the ends.

In a step S1 of this particular method, considering additively manufacturing a conductor in its longitudinal direction from the first end towards the second end, the first end segment and middle segment in the form of conductor branches of a plurality of conductor branches are monolithically formed via individual transitions that may or may not include rounded connections to shape concavely rounded interior corners between the first end segment and conductor branches of the plurality of conductor branches and to spatially separate conductor branches of said plurality of conductor branches.

The step of monolithically forming the first end segment and conductor branches may be implemented using various methods, for example methods such as additive manufacturing such as 3D printing, casting, and simply removing of material, via machining, from a bulk metal slab to form conductor branches combined with a first end segment.

More specific, a known massive conductor such as a main busbar with a length of e.g. 3-5 m may conduct 1-2 A per mm2. If the same busbar was made in an airy design and e.g. with an internal cooling, then due to the improved cooling the same 1-2 A per mm2 may be conducted with the same efficiency despite the removal of material. Typical conductor materials such as aluminium and copper have temperature coefficients at approximately 0.4%/deg C. If such conductor is efficiently cooled so that the temperature is e.g. 25 deg C lower compared to a conventional conductor, the resistance is reduced by approximately 10%. Hence approximately 10% of the material can be removed without compromising the losses. Furthermore, in AC conductors the current is not evenly distributed across the conductor volume. Typically, the current density is reduced towards the center of the conductor. Taking such considerations into account can allow for further removal of material without compromising the efficiency of the conductor.

In a step S2 of the method, the first end segment becomes electrically coupled and mechanically coupled to a second end segment via the middle segment of the electrical conductor formed by the plurality of conductor branches. This may also be monolithically achieved, e.g. by continuing the additive manufacturing, as described in step S1.

The coupling of the end segments to the middle segment could also be done by welding, gluing, male/female locking mechanism or any other way that would connect the segments both mechanically and electrically.

An optional, additional step of the method of manufacturing the conductor of the invention comprises a step prior to the step of additive manufacturing any of the first, second or middle segments. The step prior to manufacturing the electrical conductor is a step where a digital representation of the electrical conductor is designed in a software program, e.g. a 3D CAD software. The step of designing the digital representation of electrical conductor in a software program includes taking the electrical, mechanical, structural, geometry and other aspects of the physical electrical conductor into account. Thus, based on these inputs, e.g. provided by a user of the 3D CAD software, a digital representation of the conductor is provided by the 3D CAD software. When the digital representation of the electrical conductor is complete the additive manufacturing process can be started.

A further optional step may be applied i.e. a heat treatment to the finalized conductor. A heat treatment may e.g. be 4 hours at 400 C and upwards depending on the material. An advantage of heat treatment is that the particles of the manufactured conductor is mutual positioning or merging leading to higher conductivity both thermal and electrical. This is at least true for Aheadd® CP 1 20/63 aluminium powders and other aluminium-iron-zirconium powder solutions. Such powders may be used in laser powder bed fusion machineries. Using this type of powder and heat treatment may lead to higher thermal stability, thermal conductivity, corrosion performance and surface finishing as well as higher electrical conductivity.

The middle segment may in principle have any design/geometry, for example providing flexibility thereto allowing the electrical conductor to deform. It may be formed by conductor branches being solid or having internal cavities to reduce the amount of material that is needed to manufacture the electrical conductor. It may be formed by a web or as a hybrid between conductor branches or web just to mention a few possible designs.

Internal cavities may be used as cooling channels and/or additional surface for conducting high frequency current. Accordingly, the end segments and middle segments may be designed for the particular panel/electric system in which it is used, for a particular type of current to conduct, for having a desired or dual functionality, etc.

One such functionality, beside the above-mentioned may be as a structural support. Hence, if needed the electrical conductor may be designed to assist in carrying the weight of electric components connected thereto. Hence, its dimensions may be larger than what is needed by it for carrying the required current. Similarly, its geometry may be designed for the combined purpose of mechanical support and electric conductance. This is especially true if such support is flexible/deformable in that it may both assist in supporting and at the same time assist in absorbing vibrations.

It should be mentioned that the electrical conductor 1 may be manufactured in two or more resolutions. The thicker layer the faster manufacturing. The layer thickness depends on the material and printing apparatus and may vary from a few millimetres to 20 um, using some combinations the layer thickness is between 50 um and 150 um. In case of additive manufacturing resolution may be defined by thickness of the layers of which the electrical conductor is built (another word for machined and processed). A first resolution that is finer i.e. having thinner layer size than a second resolution may be used when manufacturing the interface between the electrical conductor and the part to which it is connected. Such interface may be the part of the terminal that is in contact with the other part. Alternatively, resolution may be determined by material deposition rate, material flow rate, etc. depending on the type of additive manufacturing used.

To avoid electric losses in connections between two electrical conductors it is preferred that the two parts have mating surfaces, which is most simply achieved by having planar surfaces, but may also be achieved by convex and concave combinations, mortise or finger joints, engaging teeth, cylinder and peg, tongue and groove, slide lock, etc., to further achieve additional advantages, e.g. larger surface area of connection, easier assembly of electrical conductors such as busbars in electrical systems by self-locking, etc., as long as good electrical connection is prioritized. The finer these interfaces are manufactured the better/the less post manufacturing processing is needed to ensure sufficiently mating surfaces, such as planar surfaces.

The second resolution manufactured e.g. with thicker layers would be more rough leading to more surface area. At least for middle and high frequency currents this may lead to conductance of more current without increasing the need for material/dimensions of the conductor. In fact, the middle segment may be manufactured intentionally with a corrugated surface to increase the current-carrying outer surface of the electrical conductor (current-carrying with medium and high frequencies) because of more efficient cooling due to the turbulence of, e.g., cooling air flow created due to the corrugated surface. It should be noted, that if the conductor includes an interior space, the inner surface of the conductors creating such interior space may also be corrugated for the same purpose. A corrugated surface has the effect, apart from offering a larger surface area, that it introduces turbulence in the flow of cooling fluid such as air. Increased speed of cooling fluid may lead to higher cooling effect.

As an example, the depth into the conductor which is used for conducting current at medium and high frequencies may in a specific embodiment be approximate 1.5 mm. In this specific example, the conductor is made of copper with a resistivity of approximate 1.68 uΩ cm, a relative permeability of approximate 1 at a frequency of 2 kHz. Thus, a conductor for this particular embodiment may be hollow having conductor thickness of 2 times 1.5 mm. In practice such conductor may be manufactured with a thickness of 4-5 mm leaving room for a cooling in the interior or simple reduction of conductor material and thereby weight.

Knowing that skin effect also appears at e.g. 50 Hz, a reference to a medium frequency with respect to skin effect is a reference to frequency starting around 500 Hz where the design of the conductor may account for the skin effect. The medium frequency range may be between 500 Hz and 10 kHz, above 10 kHz may be referred to as high frequency where skin effect is a fact (the higher frequency, the closer to the surface the current will be conducted).

Further, it should be mentioned that the outer surface may also be corrugated or designed with fins for increasing heat dissipation from the electrical conductor.

The electrical conductor resulting from the method may be used as an electrical conductor of an electrical installation. The electrical installation may be an electric panel which may be part of a renewable energy facility such as a wind turbine, solar system, grid, substation, etc. The electrical installation or system in which the electrical conductor is used may be an electric vehicle, battery system, power to x facility, ship or other minor or larger electric systems. Further, an electrical conductor resulting from the method can be used inside an electric panel, i.e. in a cabinet/enclosure, or outside such panel, it can be used to connect separated panels, etc.

A variant of an electrical conductor according to the present invention is connected to a traditional cable or busbar. In such embodiment, a traditional busbar e.g. in the back of an electric panel or a traditional cable e.g. between two electric panels may be connected to an electrical conductor of the invention. In this way a traditional cable or busbar may be connected to a component via a conductor according to the invention. Thereby, an easy connection is facilitated due to the flexibility of the electrical conductor of the invention.

However, note that manufacturing the electrical conductor, and thus accomplishing the electrical and mechanical coupling between the first end segment and the second end segment, is typically performed prior to installing the electrical conductor in the electrical installation, and prior to installing the electrical installation in the renewable energy facility. Thus, according to typical embodiments of the invention, the electrical and mechanical coupling is performed prior to installation/integration of the electrical conductor. Nevertheless, methods according to the invention are not necessarily restricted to a particular sequence of steps. Further, various methods according to the invention may comprise additional steps, such as performing digital geometry optimization, additively manufacturing the electrical conductor, and conducting current.

Summing up, a designer is designing a digital representation of the conductor according to electrical, mechanical, structural, etc. requirements in e.g. a 3D CAD software such as Solidworks. Files (digital representation) from such 3D developing tool is exported to e.g. a 3D printer, where the conductor is printed according to the CAD files.

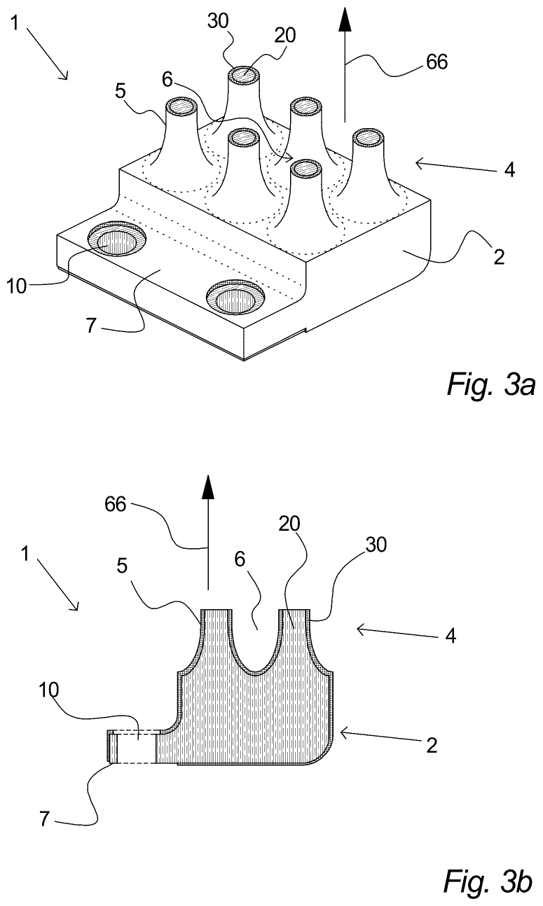

FIG. 3a-3b illustrates a perspective view and a cross section of a partial electrical conductor assembly 1 according to an embodiment of the invention. A first end 2 and a portion of the middle segment 4 is illustrated. A first terminal 7 is located in connection with the first end 2, and the first terminal 7 comprises a couple of through holes 10 and a planar, uninsulated bottom surface for establishing a firm and good electrical connection to an electrical component or another conductor, such as a busbar. The middle segment 4 comprises a plurality of conductor branches 5 spaced apart by air gaps 6.

The electrical conductor assembly 1 comprises an electrically conducting component 20 and an electrically insulating component 30. In the example of FIGS. 3a-3b, the electrically insulating component 30 generally covers the electrically conducting component 20, except around the first terminal 7. A material of the electrically conducting component 20 may for example be selected from the list of copper, aluminum, silver, gold, tin, steel, or alloys or combinations thereof. Provided the electrically insulating component 30 is a continuous surface establishing an enclosure, the electrically conducting component 20 may also be selected from mercury, gallium, electrolyte or other non-solid electrically conducting materials, or alloys or combinations thereof, preferably in combination with a solid metal for the first terminal 7. A material of the electrically insulating component 30 may for example be selected from the list of polymers, ceramics, thermoplastics, glass reinforced plastic, rubber, glass, wood, paper, oil, deionized water, or combinations thereof.

The electrically conducting component 20 is illustrated as a solid core of the electrical conductor assembly 1, but may in other embodiments comprise other geometries, shapes or configurations as described above, for example an airy geometry like bionic, lattice-like or web-like to save material and weight, and/or comprise integrated cooling channels. In such embodiments, the electrically insulating component 30 may match the geometry and configuration of the electrically conducting component 20 more or less closely, for example comprising a slightly larger version of the same geometry to match the shape of the electrically conducting component, and/or comprising a smoother, larger version to accommodate the electrically conducting component without taking on its shape completely.

The embodiment of FIGS. 3a-3b may preferably be manufactured by two-material additive manufacturing, were both the electrically conducting component 20 and the electrically insulating component 30 are built simultaneously, or at least as one single process, e.g. with synchronous or alternating addition of material to the components. The arrow 66 illustrates a preferred additive manufacturing direction 66 for the example embodiment of FIGS. 3a-3b, but any other printing direction, depending on the additive manufacturing technology, may be usable, such as transversal, radial or arbitrary. Two-material additive manufacturing may be achieved by, for example, dual nozzle Fused Deposition Modelling FDM, where one nozzle delivers an electrically conducting material in form of a wire of, preferably, copper, aluminum or an alloy, or filament comprising a mixture of metal powder in a binder. Another nozzle delivers an electrically insulating material in form of a filament, e.g. made of thermoplastics such as polylactic acid PLA or acrylonitrile butadiene styrene ABS filament. Another possibility is cold spray additive manufacturing CSAM, again with at least two nozzles, one building the electrically conducting component 20, and the other simultaneously or synchronously, such as alternatingly, building the electrically insulating component 30, e.g. with polymer or ceramics. Yet another possibility is binder jetting, where powders of electrically conducting material and electrically insulating material, respectively, may alternatingly be spread across the part being built, and after each spread, an inkjet print head is depositing binder appropriate for the particular powder at the locations where the particular powder should form the electrically conducting component 20 or electrically insulating component 30, respectively. Other dual-material additive manufacturing technologies may be applied in other embodiments.

In an alternative embodiment, the electrical conductor assembly 1 of FIGS. 3a-3b may be manufactured by first using additive manufacturing to produce the electrically conductive component 20, and afterwards applying the electrically insulating component 30 by surface treatment, e.g. coating or surface modification, or by a second additive manufacturing process. The electrically conducting component 20 may for example be manufactured by a powder bed fusion PBF technology such as selective laser melting SLM or selective laser sintering SLS, or any other suitable metal 3D-printing technology, using for example aluminum, copper or alloys, or any of the electrically conducting materials mentioned above. The electrically insulating component 30 may for example as mentioned be applied by surface treatment, e.g. painting or spraying, dip coating, etc., using any of the electrically insulating materials mentioned above. Alternatively, the electrically insulating component 30 may for example as mentioned be applied by additive manufacturing, e.g. by cold spraying CSAM or other suitable technologies, using any of the electrically insulating materials mentioned above.

FIG. 4 illustrates an electrical conductor assembly 1 according to an embodiment of the invention. A first end 2 and second end 3 are connected by a middle segment 4. First terminal 7 and second terminal 8 are located at the ends 2,3, respectively, and in this example provided with terminal holes 10 for establishing firm electrical connection to other conductors or electrical components. The middle segment 4 comprises a plurality of conductor branches 5, which are arranged in a twisted geometry, however still maintaining air gaps 6 between them for improved heat dissipation, cooling and in this geometry also providing a particularly advantageous mechanical flexibility of the electrical conductor assembly 1, as the twisted geometry with air gaps allows for slight bending or twisting of one end 2, 3 relative to the other end 2, 3 to make the terminals 7, 8 match other connection points within a larger mounting tolerance.

As indicated by the dashed contours (for simplicity and clarity only shown on some portions of the drawing, but applicable to the whole drawing), the electrical conductor assembly comprises an inner core component and an outer surface component. In this particular embodiment, the inner core component is an electrically insulating component 30, for example made of a polymer, fiber reinforced plastic or other of the electrically insulating materials mentioned above, and the outer surface component is an electrically conducting component 20, for example comprising copper, aluminum, alloys or any other suitable electrically conducting material, for example as mentioned above. The core of insulating material may reduce weight, increase flexibility, and supports further ways of manufacturing the electrically conducting component 20, as the core material 30 may act as support for an electrically conducting component 20 that is not self-supporting during manufacture and/or during use.

The electrically insulating component 30 is illustrated as a solid core of the electrical conductor assembly 1, but may in other embodiments comprise other geometries, shapes or configurations as described above, for example an airy geometry like bionic, lattice-like or web-like to save material and weight, and/or comprise integrated cooling channels, or further improve flexibility. In such embodiments, the electrically conducting component 20 may match the geometry and configuration of the electrically insulating component 30 more or less closely, for example comprising a slightly larger version of the same geometry to match the shape of the electrically insulating component 30, and/or comprising a smoother, larger version to accommodate the electrically insulating component 30 without taking on its shape completely.

As illustrated, the electrically insulating component 30 may form a core at both ends 2, 3 and the middle segment 4. In various alternative embodiments, the electrically insulating component 30 only form core in some segments, for example only in the branches 5, only in the ends 2, 3, or one of them, or in one end 2, 3 and the middle segment 4, or in sub-portions of the segments 2, 3, 4. Accordingly, the electrically insulating component 30 may in some embodiments be divided into non-continuous portions that are not connected. However, as the main purpose of the electrical conductor assembly 1 is to support current conductance between the terminals 7, 8, the electrically conducting component 20 should provide at least one continuous path and galvanic coupling between the terminals 7, 8.

The embodiment of FIG. 4 may preferably be manufactured by two-material additive manufacturing, were both the electrically conducting component 20 for surface and the electrically insulating component 30 for core are built simultaneously. The arrow 66 illustrates a preferred additive manufacturing direction 66 for the example embodiment of FIG. 4, but any other printing direction, depending on the additive manufacturing technology, may be usable, such as transversal, radial or arbitrary. Two-material additive manufacturing may be achieved by, for example, dual nozzle Fused Deposition Modelling FDM, cold spray additive manufacturing CSAM, or binder jetting, as described above with reference to FIGS. 3a-3c, and other dual-material additive manufacturing technologies may further be applied in other embodiments.

In an alternative embodiment, the electrical conductor assembly 1 of FIG. 4 may be manufactured by first using additive manufacturing to produce the electrically insulating component 30, and afterwards applying the electrically conducting component 20 by surface treatment, e.g. coating or surface modification, or by a second additive manufacturing process. The electrically insulating component 30 may for example be manufactured by Fused Deposition Modelling FDM, cold spray additive manufacturing CSAM, binder jetting or powder bed fusion PBF using a polymer such as PLA, polycarbonate, nylon or ABS, fiber reinforced plastic, ceramics, etc., and the electrically conducting component 20 may for example as mentioned be applied by surface treatment, e.g. painting or spraying, dip coating, etc., using any of the electrically conducting materials mentioned above. Alternatively, the electrically conducting component 20 may for example as mentioned be applied by additive manufacturing, e.g. by cold spraying CSAM or other suitable technologies, using any of the electrically conducting materials mentioned above.

For all of the above-described embodiments, and generally for the present invention, the electrical conductor assembly 1 may in some embodiments comprise combinations where the electrically insulating component 30 is both applied as core component like in FIG. 4 and also as a surface component like in FIG. 3a-3b, having the electrically conducting component between them, this allowing electrical insulation for safety and using, e.g. polymers or ceramics as support for the conducting material. The electrical conductor assembly 1 may in some embodiments comprise combinations where the electrically conducting component 20 is both applied as core component like in FIG. 3a-3b and also as a surface component like in FIG. 4, having the electrically insulating component between them, for example to provide for galvanically separate current paths in one monolithic unit.

FIG. 5 illustrates a non-limiting, simplified example of a dual-material additive manufacturing equipment 60, which in this example is in the process of manufacturing an electrical conductor assembly 1 as described above with reference to FIGS. 3a-3b. The additive manufacturing equipment illustrated may be a Fused Deposition Modelling FDM equipment, having a first nozzle 62 applying electrically conductive material for building the electrically conductive component 20, and a second nozzle 64 applying electrically insulating material for building the electrically insulating component 30. For simplicity, the illustration does not show mounting and movement systems for the nozzles and the table, material storing and conveying means, temperature control systems, controllers, power supplies, user interfaces, or other parts of the additive manufacturing equipment 60 known to the skilled person. The two nozzles 62, 64 may be actively applying material simultaneously or synchronously, such as alternatingly, so that the electrical conductor assembly 1 is built step by step as a single polylithic unit. The same additive manufacturing equipment 60 may be utilized for manufacturing other embodiments described herein, for example the embodiment of FIG. 4.

In various other embodiments, the additive manufacturing equipment 60 may be arranged for binder jetting, whereas the nozzles are replaced by binder inkjet-like heads, or for example for powder bed fusion PBF, where the nozzles are replaced with, e.g., laser emitters.

FIG. 6 illustrates an embodiment of an electrical conductor assembly 1 according to the invention. The electrical conductor assembly 1 comprises first and second ends 2, 3, a middle segment 4, first and second terminals 7, 8, conductor branches 5 separated by airgaps 6, as described above for the previous embodiments. Due to a web-like or lattice-like geometry of the branches 5, several intersection points 9 between conductor branches 5 exist. Like the embodiments described above, the present embodiment features an airy geometry with reduced material and weight, as well as improved heat dissipation and cooling options. Further general aspects of this embodiment are described with reference to FIG. 1b above.

Further, the embodiment of FIG. 6 comprises an electrically conducting component 20 which may preferably be manufactured by additive manufacturing as described above, as well as an electrically insulating component 30 covering a part of the surface of the electrically conducting component 20. The partial insulation of the conducting part facilitates reduced safety clearance at those portions, which may be beneficial when the electrical conductor assembly 1 is to pass through narrow spaces as described above, or when it is beneficial to allow the electrical conductor assembly to pass by another conductor at low or no distance. This embodiment is particularly advantageous for high-power electrical systems, e.g. as a high-power electrical local connection busbar, with high voltages requiring larger safety clearance when relying on air insulation.

The electrically insulating component 30 is illustrated with a complex shape providing a non-flat outer surface, as well as several air channels between the electrically conducting component 20 and the electrically insulating component 30. For illustration purposes, the complex shape and air channels are shown to a much larger scale than preferred. The non-flat outer surface may facilitate turbulence of air flow for cooling, and the air channels between the conducting and insulating components may facilitate heat dissipation even where the conductor assembly is covered by insulation. It is also noted that the web-like design of this embodiment allows cooling air to pass through inside the conductor outer perimeter, and thereby also unrestricted flow through the insulated portion. In various embodiments, the electrically insulating component 30 may be a simpler geometry, such as a flat-surfaced sleeve, or even more complex geometries, possibly comprising air guides, mounting points, etc. In various embodiments, the electrically insulating component 30 may form several connected or separate transversal bands on the electrical conductor assembly 1.

In the embodiment of FIG. 6 the electrically insulating component 30 may preferably be manufactured and applied to the electrically conducting component 20 in one process by using additive manufacturing, e.g. simultaneously or synchronously with the manufacturing of the electrically conducting component 20, or by a subsequent, separate additive manufacturing step. Alternatively, the electrically insulating component 30 may be manufactured and applied by surface treatment, such as coating or surface modification.

FIG. 7 illustrates an embodiment of a separate additive manufacturing of an electrically insulating component 20 of an electrical conductor assembly 1 of the embodiment described above with reference to FIG. 6. A cold spray additive manufacturing CSAM equipment 60 is provided. In various embodiments, the part 1 and/or the nozzle 62 may be fixedly mounted, or may preferably, as illustrated, be moveably mounted, preferably by means of multi-joint arms, allowing a high degree of freedom of moving and rotating both part 1 and nozzle 62, and thereby allowing for arbitrary additive manufacturing direction, whereby this direction is not indicated in the drawing. In some embodiments the part 1 or nozzle 62 may be mounted in a turning lathe to only allow rotatably motion, thereby causing the additive manufacturing direction to be radial to the rotation axis, and allowing the applied layers to be curved.

In an embodiment, the cold spray additive manufacturing CSAM equipment 60 may further include two nozzles with different spray material in order to manufacture the electrically conducting component 20 and the electrically insulating component 30 simultaneously or synchronously.

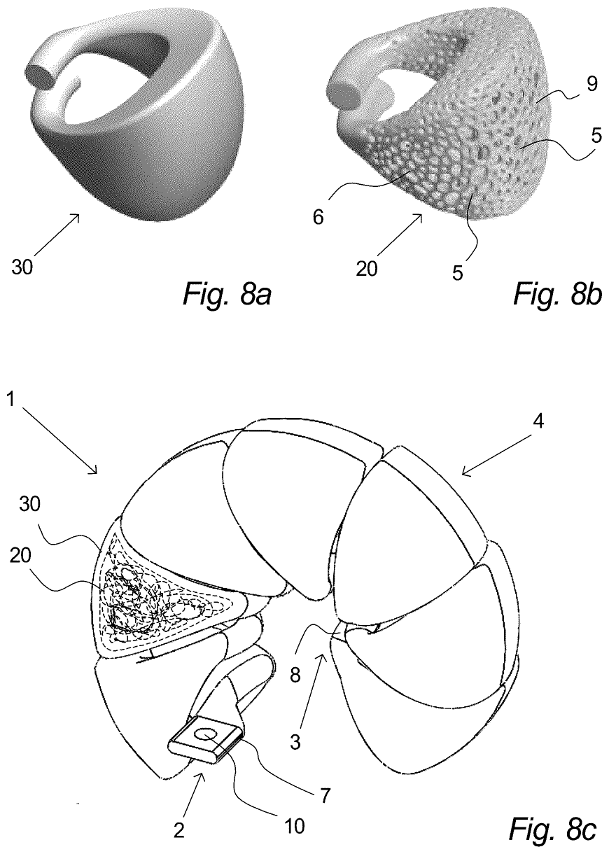

FIGS. 8a-8c illustrates an embodiment where the electrical conductor assembly 1 forms a helical coil 1 of FIG. 8c consisting, in this example, of seven electrical windings as the one illustrated in FIGS. 8a and 8b. The electrical windings have a non-uniform geometry according to an embodiment of the present invention, and the electrical windings may be connected in series with additional electrical windings having a uniform or non-uniform geometry to form a helical coil structure such as the one illustrated e.g. in FIG. 8c, around an air core as illustrated, or around, for example, a ferromagnetic material core.

The helical coil formed by electrical conductor assembly 1 comprises a first and second end 2, 3, with first and second terminals 7, 8, for connection to other components or conductors, and configured to support current conductance between the terminals, i.e. through the coil. As indicated in simplified version in FIG. 8c, the electrical conductor assembly 1 comprises an electrically conducting component 20 of web-like structure as also illustrated in FIG. 8b without being covered, and an electrically insulating component 30 as also illustrated in FIG. 8a, covering the electrically conducting component 20 for example for safety purposes or for simpler mounting requirements. The electrically conducting component 20 comprises conductor branches 5 with intersection points 9 and airgaps 6 to separate them, allow for improved heat dissipation and cooling, and reduce material and weight.

The complex geometry of the coil windings may be advantageous for enabling exploiting the ambient area at the outer side of the core which is larger than the ambient area of the inner side of the core. More specifically, in theory the outside of the core adjoins an infinite space, part of which can be filled up with the outer part. In contrary, the inner part adjoins a finite space, at least when the core is a closed core, thus there is a limited space for the geometry of the inner part before it is limited by the opposing part of the core. Hence, the geometry of the outer part can be designed with the purpose of heat dissipation whereas the geometry of the inner part can be designed with the purpose of exploiting the limited space inside the closed core. This is especially advantageous in an embodiment where several electrical windings are connected in series as illustrated e.g. in FIG. 8c.

Alternative geometries exists and just to mention a few these alternatives include oval, box-like, spiral, geometries comprising a plurality of conductors that are spaced apart, perforated or non-perforated surfaces, etc.

The geometry of the electrically conducting component 20 of the winding illustrated in FIG. 8b is only one example of a geometry which could be referred to as spongy, bionic, web-like or lattice-like. Hence, other geometries could be designed as a web, flat, squares, cylindrical, honeycomb, triangular, etc. i.e. from one geometry of the winding at the inner part change or branching off into another geometry at the outer part. Further options include multi-layer design, twisted design, etc.

Like the electrically conducting component 20, the electrically insulating component 30 may also in alternative embodiments comprise an airy geometry of, e.g. web-like or bionic geometry. Preferably this follows the geometry of the electrically conducting component 20 to ensure proper electrical insulation of all conductor branches when that is a purpose, but thereby also facilitating improved heat dissipation and air cooling by opening up the insulation surface and allowing air through the entire winding and coil.

Accordingly, the electric conductor 1 may comprise one first conductor branch 5 that may branch off to a plurality of second conductor branches 5, each of these second conductor branches may further branch off to a plurality of third conductor branches 5 and so on through the middle segment of the electric conductor 1. In this way, following the direction of the current flow through the electric conductor 1 from a first end to a second end, current is allowed to flow in the first conductor branch, then allowed to divide into a flow in the second conductor branches and again allowed to divide into a flow in the third conductor branches and so on into additional nth conductor branches.

In an embodiment, if current is flowing from a first end segment to a second end segment, the first conductor branch may have a first cross-sectional area, the second conductor branches may have a second cross-sectional area which is smaller than the first cross-section area. Following, the third conductor branches may have a cross-sectional area smaller than the second cross-sectional area. Accordingly, the cross-sectional area of the conductor branches may be varied in size in the longitudinal direction of the middle segment.

As described above, the conductor branches of the electric conductor may branch off into a plurality of additional (n^{th}) conductors. In the same way, the conductor branches may also converge from a higher number of conductor branches into a lower number of conductor branches.

It should be mentioned that a cross-sectional area of the middle segment at one distance from a first end segment may be the same as a cross-sectional area of the middle segment at a second distance from the first end segment while the number of conductor branches at the first distance is different from the number of conductor branches at the second distance.

Further, it should be mentioned that the cross-sectional area of the middle segment at the first and second distances from a first end segment may be different while the number of conductor branches may be the same. Of course, the cross-sectional area and the number of conductor branches may also be the same at the first and second distances from the first end segment.

The branching off may be in one plane. This plane may be of a tangent to the surface of an electrical conductor having a curved design. Further note that such branching off may either be at the within the fixed uniformity of the conductor and/or it may be from one conductor to another e.g. via a joint/fixing of two conductors.

It should be mentioned that embodiment of the electrical conductor may also include designs where the conductor branches branch off from the first end segment to a plurality of conductor branches and converge again into the second end segment without branching off between the first and second end segments.

As described for the embodiments of FIGS. 3a, 3b and 4, a dual-material additive manufacturing process may be used to manufacture the electrical conductor assembly 1 of the embodiment of FIGS. 8a-8c simultaneously or synchronously as one polylithic unit, or either the electrically conducting component 20 or the electrically insulating component 30 be manufactured by additive manufacturing first, and the other component applied by surface treatment or a second additive manufacturing step.

In an embodiment, also applicable to the other embodiments described elsewhere herein, when manufacturing by additive manufacturing the electrically insulating component 30 as a closed, hollow unit only being open at the ends, the electrically conducting component 20 may be supplied in liquid form, e.g. a fluid metal such as mercury or gallium alloys, or an electrolyte, into the hollow electrically insulating component 30. Subsequently, depending on the conducting material, the electrically conducting material 20 may be allowed to solidify to form a solid conductor, or it may remain in liquid form, e.g. allowing pumping it through the electrical conductor assembly 1 for cooling, before re-entering the interior portion.

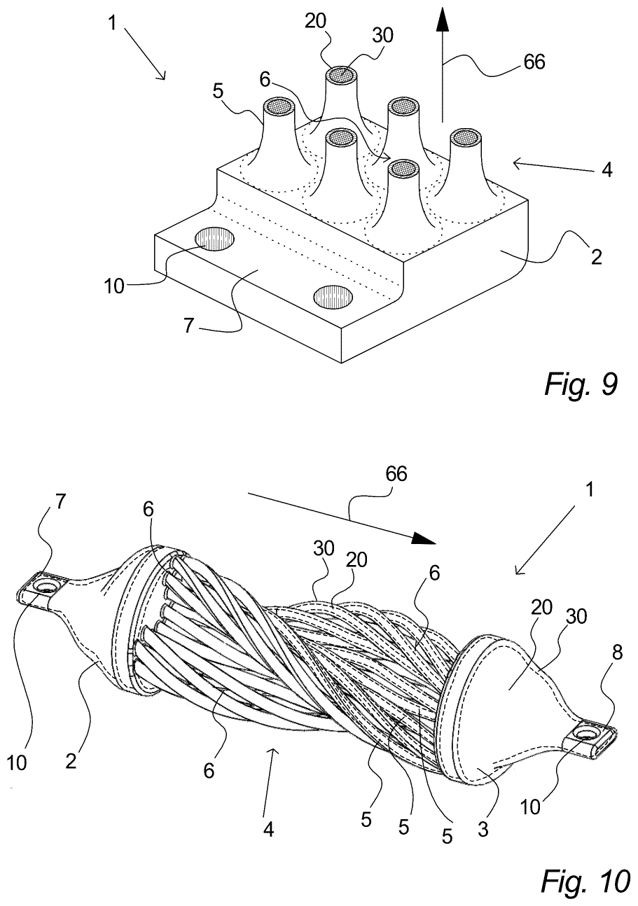

Turning back to the embodiment of FIGS. 3a-3b and FIG. 4, it is noted, that in various embodiments the electrically conducting component 20 and the electrically insulating component 30 are swapped. This is illustrated in FIGS. 9-10. FIG. 9 illustrates an electrical conductor assembly 1, with an electrically insulating component 30 as core component, and an electrically conducting component 20 as surface component. The electrical conductor assembly 1 may as described be manufactured by dual material additive manufacturing simultaneously or synchronously as one polylithic unit, or either the electrically conducting component 20 or the electrically insulating component 30 be manufactured by additive manufacturing first, and the other component applied by surface treatment or a second additive manufacturing step. FIG. 10 illustrates an electrical conductor assembly 1, with an electrically conducting component 20 as core component, and an electrically insulating component 30 as surface component. The electrical conductor assembly 1 may as described be manufactured by dual material additive manufacturing simultaneously or synchronously as one polylithic unit, or either the electrically conducting component 20 or the electrically insulating component 30 be manufactured by additive manufacturing first, and the other component applied by surface treatment or a second additive manufacturing step.

Like the embodiments of FIGS. 4 and 9, and 6 and 10, resemble the electric conductor assembly 1 of FIGS. 1a and 1b, respectively, the airy, bionic embodiment of FIG. 1c, described above, may accordingly be manufactured with an electrically conducting component 20 and an electrically insulating component 30, preferably in one manufacturing process to form a polylithic unit as described, or by manufacturing one component by additive manufacturing, and the other part by separate additive manufacturing or by surface treatment.

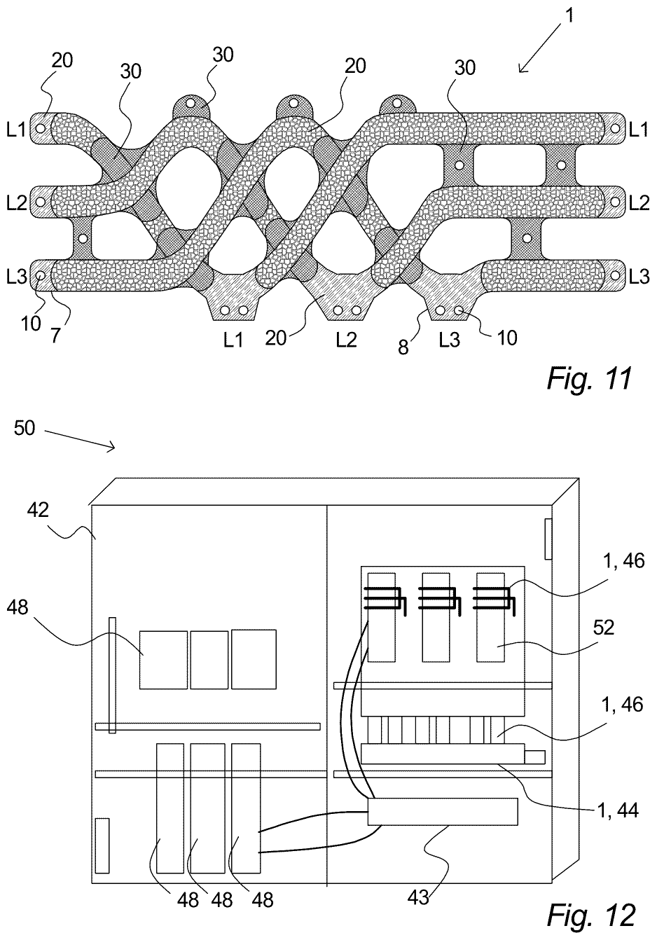

FIG. 11 illustrates a multi-phase electric conductor assembly 1 according to an embodiment of the invention, in this example particularly 3 phases L1, L2, L3. The electric conductor assembly 1 comprises three galvanically separate electrical conductor components 20 to carry the 3 separate phases L1, L2, L3, and correspondingly three of each first terminals 7 and second terminals 8. The multi-phase electrical conductor assembly 1 may preferably be utilized as a busbar, such as a main busbar or connecting busbar, also referred to a high-power electrical local connecting busbar, in high-power electrical systems, e.g. power converters.

In the particular configuration of FIG. 11, the terminals are manufactured with planar surfaces for simple and firm electrical connection to other conductors or electrical components, whereas the electrically conducting components 20 between the terminals are manufactured in an airy bionic, web-like or lattice-like geometry. Electrical conductor assembly embodiments of such geometry are described above, with the various description and alternatives also applicable here, for example regarding conductor branches 5, airgaps 6, intersection points 9, ends and middle segments 2, 3, 4, etc., auxiliary functions like flexibility, cooling, heat dissipation, etc., various manufacturing methods, etc. Other geometries of the electrically conducting component 20 as described herein are also applicably to the electrical conductor assembly 1 of FIG. 11. Further, in the particular configuration of FIG. 11, electrically insulating components 30 are provided at various select portions of the electric conductor assembly 1. For example, electrically insulating components 30 may be formed between separate phase conductors L1, L2, L3 to allow for reduced safety clearance which in turn may reduce the footprint of, for example a main busbar replaced by the multi-phase electrical conductor assembly 1. For example, electrically insulating components 30 may be formed at select surface portions of the phase conductors L1, L2, L3 where operators or service technicians may come close to the busbar in connection with their work. For example, electrically insulating components 30 may be formed as support structures for maintaining the relative position of the separate phase conductors L1, L2, L3 to each other. For example, electrically insulating components 30 may be formed as mounting points for mounting the multi-phase electrical conductor assembly 1 to a cabinet or panel, for example for each 25 to 35 cm, without requiring further insulating material to be provided for the mounting. Alternatively, insulated mounting points may be formed as hooks, clamps, latches, etc., for easy mounting without bolts.

The electrical conductor assembly 1 of this embodiment may advantageously be manufactured completely by additive manufacturing to form a polylithic unit, where the phase conductors L1, L2, L3, although galvanically separate, are interweaved in a way that may not be easily achieved, if possible at all, by combining individually manufactured conductors, and further are intrinsically combined by patches of electrically insulating component 30. The alternative manufacturing methods described in relation to other embodiments herein are also applicable for this embodiment, such as manufacturing, e.g., the electrically conducting components 20 by additive manufacturing, and the forming the electrically insulating components 30 by a separate additive manufacturing step, or by surface treatment methods, such as coating or surface modification.

A multi-phase electrical conductor assembly 1 may be highly advantageous for multiphase electrical systems as it may replace conventional, separate busbars consisting of heavy solid copper bars or rails, which require large safety clearances, several different connecting busbars for the difference phases, manual insulation application, additional insulation for mounting, separate mounting means, etc. The present invention allows for providing a single unit which offers all the relevant functions for a high-power multi-phase busbar. Further advantages which are not conventionally achieved include that all phase conductors may have the same distance between the terminals, to avoid discrepancies in resistive loss, heat distribution, etc. The multi-phase electrical conductor assembly 1 may in various embodiments comprise any number of galvanically separate electrically conducting components 20, such as one, two, three, four, five, six, or any other number of busbars. While the multi-phase electrical conductor assembly 1 is shown here with a twisted wire-like configuration, the phase conductors may in various embodiments comprise any inter-conductor geometry, including parallel phase conductors, etc.

FIG. 12 illustrates an embodiment of a high-power electrical system 40 of the invention. The electrical system 40 comprises an electrical cabinet 42, typically made of metal, containing high-power electrical components 48, e.g. power modules 52, power converters, breakers, transformers, high-voltage capacitors, resistors, or inductors, etc. The electrical system 40 may for example be a renewable energy power converter, a high-power battery charger, etc., as described elsewhere herein. The electrical system 40 is connected to external electrical systems such as an electrical generator, a grid, a battery or a motor, by at least one in-feed and/or out-feed cable or wire, preferably a three-phase in-feed and a three-phase out-feed, a three-phase in-feed and a DC out-feed, or a DC in-feed and a three-phase out-feed. A main busbar 44, also referred to as high-power electrical local connecting busbar, serves as main distributor of the in-and/or out-feed connections to the electrical components 48, via a number of transition busbars, connections busbars or shunts 46, which may also be referred to as high-power electrical local connecting busbars.

Electrical conductor assemblies 1 of the present invention may advantageously be used as main busbar 44, and/or transition busbars, connecting busbars or shunts 46. For example, the embodiment of FIG. 11 is an advantageous replacement for conventional main busbars. For example, the embodiments of FIGS. 1a-1c, 3a-3b, 4, 6, 9-10, may serve as advantageous replacements for various connection busbars between electrical components, busbars and combinations thereof, in an electrical system 40. For example, the embodiment of FIG. 8 may serve as advantageous replacement for a conventional inductor or reactor electrical component of high-power electrical systems.

In FIG. 12, the particular electrical system 40 illustrated is a high-power converter 50 according to an embodiment of the invention. This converter 50 is enclosed in an electrical cabinet 42 comprising electrical components 48 such as circuit breakers of which the back side is illustrated. This circuit breakers are also connected to a power infeed of converter 50. The power supply to the converter 50 may be the grid or a local power generator such as a wind turbine or a solar panel.

The circuit breakers 48 are in this embodiment connected to other electrical component 48 such as reactors or inductors 48 in the bottom of the cabinet 42 with cables. Further, cables connect the reactors 48 to power modules 52.

The output side of the power modules 52 are in this embodiment connected to a laminated busbar plates behind the power modules 52, which via transition busbars 46 are connected to main output busbars 44. This main output busbars are connected to outfeed of the power converter 50, to which, e.g., a load or grid may be connected.

The power modules 52 have several transition busbars 46 provided to receive cable connections from the reactors/inductors and distribute current between the power module inputs. The transition busbars 46 are highly specialized to achieve various functions, fit the available space and clearance requirements, and to achieve a sufficient heat transfer and cooling in the cabinet 42. Due to the specialization, conventional busbar manufacturing is disadvantageous, and the busbars 46 may advantageously be printed by additive manufacturing.

The busbars 1, 44, 46 may advantageously be electrically conductor assemblies 1 of the present invention comprising an electrically insulating component for more or less of their surface areas. A busbar 1, 44, 46 of the present invention may be manufactured at least partly by an additive manufacturing process and thus the geometry may be tailor made to the footprint, available space, cooling capacity, current capacity, etc. that is limiting or required from the transition busbar. A few examples of geometry and design of suitable electrically conductor assemblies 1 are illustrated above in FIGS. 3a-3b, 4, 6, 9, 10 and 11, and the embodiment shown in FIGS. 8a-8c may be advantageous for reactor/inductor in the power converter 50.

It should be mentioned that studs may be provided on the surface of electrical conductor assemblies 1 comprised by the cabinet 42 of the present invention. Studs are advantageous in that if located e.g. every 5 mm then they will create a turbulence at the surface which increases the cooling efficiency of the busbars. The studs may be attached during manufacturing such as during additive manufacturing or post manufacturing e.g. via cold spray.

The power modules 52 comprise a plurality of semiconductor switches such as IGBTs. These power modules 52 are controlled by a converter controller so as to perform the function of e.g. an inverter or rectifier. On that node, the illustrated power converter 50 is an AC to DC converter where three phases e.g., from the utility grid enter the converter 52 and is converted to a DC supply e.g., for an electrolyser. It should be noted that the converter 52 may also be a DC to AC, DC to DC, or AC-AC converter.

The converter 52 may comprise a filter e.g. comprising capacitors, damping resistors, and trap chokes. This filter may be included in the converter to ensure that the output voltage from the converter is smoothed e.g. to comply with grid codes.

The converter 50 may comprise a cooling system 43. The cooling system may include cooling loops via which the components such as the reactor, filter and power modules are cooled. The cooling system may circulate a cooling fluid, such as a liquid or gaseous coolant. Such liquid coolant may e.g. be selected as a type of oil which may be non-electrical conductive and thereby work as both cooling fluid and isolator, water, deionized water, Glycol, liquid, metal such as Gallium, mercury, etc. The cooling system may circulate the cooling fluid in the cooling loop with a flow speed in the range of 4 L/min to 10 L/min per power module. Therefore, the cooling system should be able to provide a flow of cooling fluid in the range of 48 L/min to 120 L/min in electrical systems having parallel power modules on each of three phases (12 power modules×4-10 L7min). The temperature of the cooling fluid is preferably below 55 C in that it is desired to maintain a temperature below 55 C in the high-power electric system.

More specific, a known massive conductor such as a main busbar with a length of e.g. 3-5 m may conduct 1-2A per mm 2. If the same busbar was made in an airy design and e.g. with an internal cooling, then due to the improved cooling the same 1-2A per mm 2 may be conducted with the same efficiency despite the removal of material. Typical conductor materials such as aluminium and copper have temperature coefficients at approximately 0.4%/deg C. If such conductor is efficiently cooled so that the temperature is e.g. 25 deg C. lower compared to a conventional conductor, the resistance is reduced by approximately 10%. Hence approximately 10% of the material can be removed without compromising the losses. Furthermore, in AC conductors the current is not evenly distributed across the conductor volume. Typically, the current density is reduced towards the center of the conductor. Taking such considerations into account can allow for further removal of material without compromising the efficiency of the conductor.

Further, a conductor such as a transition busbar having internal cooling channel and an airy design having a length of e.g. 1-2 m may conduct 10-15 A per mm2 and in an extreme case with massive cooling an a distance no longer than e.g. 10 cm, such conductor may conduct 50 A per mm2. Care should be taken when reducing the cross-sectional area in that more heat is generated which need to be removed if the same current should be conducted by a smaller cross-sectional area. The loss increases quadratic with the increase of current. Therefore, the efficiency of the conductor is also reduced when the material hereof is reduced.

In addition to the above-mentioned features, the electrical conductor assembly 1 may include one or more of several additional features which makes it advantageous over prior art busbars. One such feature is a non-uniform geometry of busbars 1. With non-uniform and tailormade busbars 1 it is possible to make a more compact design of the electrical system 40, e.g. power converter 50, in that the busbar (including main and transition busbars) may be shaped according to available space and location of components in the cabinet. This may include branching off in two or more conductor branches, change to an airy design if additional cooling for some reason is required, narrow the cross-sectional area of the conductor 1 and thereby establish a heater if required for some reason of if the conductor 1 has to go through a current sensor, etc. As an example of the advantage of being able to create heat could be mentioned that during start up, if a certain part of a cabinet is prone to condensation, that part of the cabinet may be heated up by conducting current through a narrow cross-sectional area of the conductor in such area. Another example is a circuit breaker which may require a certain heat dissipation from a connected conductor. Such requirement to heat dissipation may be complied with, with less material by a conductor with varying/airy geometry compared to known massive conductors. In fact, it may be possible to rate up the circuit breaker due to the optimized heat dissipation from the conductor connected to the circuit breaker.

Another such feature is the additive manufacturing of an electrical conductor assembly 46 for the connection of the power modules 52. These conventionally set of several busbars with different functions may, by additive manufacturing, be monolithically formed as one single busbar including all the benefits from the individual busbars. Hence, one multifunctional busbar may be manufactured having varied cross-sectional area according to where cables are connected, conducting of current, cooling, facilitates mount of several such as five ferrite cores and flexibility, and with partial insulation at select portions of the surfaces. By manufacturing one multifunctional electrical conductor assembly with two or more of these characteristics' material may be saved, better cooling may be obtained, more flexible busbar may be provided leading to easier mounting, the number of connections of busbars is reduced and a more compact layout of the converter 50 may be achieved. Such multifunctional busbar may have a wedge formed part for connecting cables, a twisted design allowing the conductor to form a solenoid of five windings around a core and a branch off for connecting to the power modules.

Further, mounting such multifunctional busbar is faster than connecting four individual busbars and less manual mounting eliminate sources of errors and when connecting two parts requires space for tool and larger distances to other components in general due to concerns of tolerances. Further, by using busbars with airy design and/or internal cooling channels the design can be more compact because of the optimized cooling and thus busbars 1 may be located closer to other components.

In an embodiment, having an electrically insulating component 30 as core component, such as illustrated in, e.g., FIGS. 4 and 9, may for example facilitate embodiments where the electrically insulating component 30 comprise channels longitudinal or transversal to the conductor branches, such as inside or between the conductor branches 5. Such channels are electrically insulated, and may be used for internal cooling with cooling fluids that are not supposed to get in contact with the electrically conducting component for safety reasons or to avoid corrosion. Such insulated channels may in the same or alternative embodiments enable insertion of wires, e.g. for communication or control signals, sensors, etc. into the electrical conductor assembly 1.

In an embodiment, having an electrically insulating component 30 as surface component, such as illustrated in, e.g., FIGS. 3a, 3b, 6, 8 and 10, when particularly when manufacturing the electrically insulating component 30 simultaneously or synchronously with the electrically conducting component 20, or when applying the electrically insulating component 30 by additive manufacturing, inherent non-insulation by design may be achieved at, e.g. terminals and other locations where access to the electrically conducting component 20 is required. This avoids the manual removal of insulation with possible damaging the conductor at such locations, which is normally required for insulated electrical conductor assemblies.

In an embodiment, an electrical conductor assembly 1 has insulated mounting points, thereby avoiding manually adding insulation to mounting points or using insulation plates or non-conducting structures for mounting of electrical conductor assemblies, such as busbars, particularly advantageous in high-power electrical systems. By means of the invention, an embodiment with partial insulation at select portions of the conductor branches, non-insulated terminals for electrical connections, and insulated mounting points for safe mounting, may advantageously be provided in a single additive manufacturing process.

### LIST OF REFERENCE SIGNS

1 Electrical conductor assembly, busbar
2 First end
3 Second end
4 Middle segment
5 Conductor branch
6 Air gap
7 First terminal
8 Second terminal
9 Intersection point
10 Terminal hole
20 Electrically conducting component
30 Electrically insulating component
40 Electrical system
42 Electrical cabinet
44 Main busbar
46 Transition busbar, connecting busbar, shunt
48 Electrical components
50 Power converter
52 Power module
60 Additive manufacturing equipment
62 Additive manufacturing first nozzle
64 Additive manufacturing second nozzle
66 Additive manufacturing direction
L1, L2, L3 Separate phase conductors

1.-40. (canceled)

41. An electrical conductor assembly comprising an electrically conducting component and an electrically insulating component, wherein the electrically conducting component is configured to conduct an electrical current between a first terminal and a second terminal of the electrical conductor assembly,
wherein at least one of the electrically conducting component and the electrically insulating component is manufactured by additive manufacturing, and
wherein the electrical conductor assembly is a multiphase electrical conductor assembly comprising at least two separate electrically conducting components that are intrinsically combined by patches of the electrically insulating component.

42. The electrical conductor assembly of claim 41, wherein the electrically insulating component is manufactured together with the electrically conducting component by multi-material additive manufacturing.

43. The electrical conductor assembly of claim 41, wherein the electrically conducting component and the electrically insulating component are arranged substantially parallel in the electrical conductor assembly.

44. The electrical conductor assembly of claim 41, wherein the electrically insulating component forms one or more transversal bands on the electrically conducting component.

45. The electrical conductor assembly of claim 41, wherein the electrically conducting component includes a first material, and the electrically insulating component includes a second material different from the first material.

46. The electrical conductor assembly of claim 41, wherein the electrical conductor assembly is an electrical busbar.

47. The electrical conductor assembly of claim 41, wherein the electrical conductor assembly is a component configured for electrical distribution in an electrical system.

48. The electrical conductor assembly of claim 41, wherein the electrical conductor assembly includes a transition busbar, a connecting busbar, or a shunt, configured to connect electrical components or other busbars with main busbars or cables.

49. The electrical conductor assembly of claim 41, wherein the electrically conducting component of the electrical conductor assembly includes two or more separate phase conductors, each having first and second terminals and supporting individual current conductance between the respective first and second terminals.

50. The electrical conductor assembly of claim 41, wherein the electrical conductor assembly has a resonance vibration frequency of at least 5 Hz.

51. An electrical system comprising:
one or more electrical components connected to one or more electrical conductors, at least one of the electrical conductors being an electrical conductor assembly including an electrically conducting component and an electrically insulating component, at least one of which is manufactured by additive manufacturing,
wherein the electrical conductor assembly is a multiphase electrical conductor assembly including at least two separate electrically conducting components that are intrinsically combined by patches of the electrically insulating component.

52. The electrical system of claim 51, wherein the electrical system is a high-power electrical system and the electrical conductor assembly is a high-power electrical local connecting busbar.

53. The electrical system of claim 51, wherein the electrical system further comprises a power converter, including one of an AC-DC converter, a DC-AC inverter, an AC-DC-AC converter, a frequency control driver, or a battery charger.

54. The electrical system of claim 51, wherein at least one of the one or more electrical components including a switch mode power module, which includes one of an insulated-gate bipolar transistor IGBT power module or a metal-oxide semiconductor field-effect transistor MOSFET power module.

55. The electrical system of claim 51, wherein the electrical system is a three-phase electrical system.

56. A method of manufacturing an electrical conductor assembly, comprising steps of:
assembling a multiphase electrically conducting component and an electrically insulating component; and
manufacturing the electrically conducting component and the electrically insulating component by additive manufacturing so that the multiphase electrical conductor assembly includes at least two separate electrically conducting components that are intrinsically combined by patches of the electrically insulating component.

57. The method of claim 56, wherein the assembling comprises building the at least two electrically conducting component and the patches of electrically insulating component concurrently by multi-material additive manufacturing.

58. The method of claim 56, wherein the electrically conducting component comprises a first material and the second component comprises a second material different from the first material.

59. The method of claim 58, wherein the first material includes one or more of copper, aluminum, silver, gold, tin, steel, mercury, gallium, an electrolyte, or an alloy.

60. The method of claim 58, wherein the second material includes one or more of: a polymer, a ceramic, a thermoplastic, a glass reinforced plastic, a rubber, a glass, a wood, a paper, an oil, or deionized water.
